(19) United States
(12) Patent Application Publication
(10) Pub. No.: US 2010/0322580 A1
(43) Pub. Date: Dec. 23, 2010

(54) Fiber Optic Cable Parking Device

(76) Inventors: Hubert B. Beamon, Haltom City, TX (US); Terry L. Cooke, Hickory, NC (US); Dave E. Cunningham, Conover, NC (US); David L. Dean, JR., Hickory, NC (US); Jonathan A. Holt, Hickory, NC (US); Kevin L. Strause, Keller, TX (US)

Correspondence Address: CORNING INCORPORATED, INTELLECTUAL PROPERTY DEPARTMENT, SP-TI-3-1, CORNING, NY, 14831, US

(21) Appl. No.: 12/818,986

(22) Filed: Jun. 18, 2010

Related U.S. Application Data
(60) Provisional application No. 61/219,251, filed on Jun. 22, 2009.

(51) Int. Cl. G02B 6/46

(52) U.S. Cl. 385/135

(57) ABSTRACT

A fiber optic apparatus,with a panel, having a front and a back and mountable in a chassis is disclosed. The panel has a parking port in the back adapted to removably receive an adapter. The panel also has a connection port in the front adapted to removably receive the adapter. The adapter is selectively movable between the parking port and the connection port. One end of the adapter opens toward the front and another end of the adapter opens toward the back. The adapter is removably received in the parking port, and a connector attached to a fiber optic cable inserts in the end opening toward the back. The adapter then may be moved from the parking port to the connection port and removably received in the connection port. Another connector attached to another fiber optic cable may be inserted in the other end of the adapter opening toward the front.

### PRIORITY APPLICATION

This application claims the benefit of U.S. Provisional Application Ser. No. 61/219,251 filed on Jun. 22, 2009, the entire contents of which are incorporated by reference herein.

### BACKGROUND

1. Field of the Disclosure

The technology of the disclosure relates to fiber optic apparatus for installing fiber optic cable in a fiber optic equipment rack or cabinet, including a device for temporarily parking a fiber optic cable to facilitate installation in a fiber optic equipment rack or cabinet.

2. Technical Background

Benefits of optical fiber include the ability to transmit voice, video and data signals at extremely fast data rates for long distances with low noise operation. Because of these advantages, optical fiber is increasingly being used for a variety of applications, including but not limited to broadband voice, video, and data transmission. Fiber optic networks employing optical fiber are being developed and used to deliver voice, video, and data transmissions to subscribers over both private and public networks. These fiber optic networks often include separated connection points linking optical fibers to provide “live fiber” from one connection point to another connection point. In this regard, passive fiber optic connection equipment (here on simply referred to as fiber optic equipment) is located in data distribution centers or central offices to support passive optical interconnections.

The fiber optic equipment is customized based on the application need. The fiber optic equipment is typically included in housings that are mounted in equipment racks for organizational purposes and to optimize use of space. One example of such fiber optic equipment is a fiber optic module. A fiber optic module is designed to transition one type of optical connector into a different type of optical connector(s) and manage the polarity of fiber optic cable connections. Due to increasing bandwidth needs and the need to provide a larger number of connections in data centers for increased revenue generating opportunities, an increasing quantity of fiber optic cables are routed between fiber optic equipment to support the larger numbers of fiber optic connections in a given space.

The larger number of fiber optic connections in a given space includes a larger number, or, in other words, increased density, of trunk cables routed to and between fiber optic equipment racks or cabinets. With this increased density, the installation and management of the trunk cables is critical. Typically, such installation and management of the trunk cables requires access to the rear of the fiber optic equipment rack or cabinet. Time and costs, including as attendant to the labor involved with trunk installation and management, is, generally, higher than installation and management from the front of the fiber optic equipment rack and cabinets.

### SUMMARY OF THE DETAILED DESCRIPTION

In one embodiment there is provided a fiber optic apparatus,with a panel, having a front and a back and mountable in a chassis. The panel has a parking port in the back adapted to removably receive an adapter. The panel also has a connection port in the front adapted to removably receive the adapter. The adapter is selectively movable between the parking port and the connection port. One end of the adapter opens toward the front and another end of the adapter opens toward the back. The adapter is removably received in the parking port, and a connector attached to a fiber optic cable inserts in the end opening toward the back. The adapter then may be moved from the parking port to the connection port and removably received in the connection port. Another connector attached to another fiber optic cable may be inserted in the other end of the adapter opening toward the front.

In a further embodiment there is proved a method for connecting fiber optic cables. The method includes providing a transition panel having a parking port and a connection port; inserting an adapter in the parking port; extending to the transition panel a first fiber optic cable with a first connector attached to an end; inserting the first connector in an end of the adapter; moving the adapter from the parking port to the connection port; extending to the transition panel a second fiber optic cable with a second connector attached to an end; and inserting the second connector in another end of the adapter.

Additional features and advantages will be set forth in the detailed description which follows, and in part will be readily apparent to those skilled in the art from that description or recognized by practicing the invention as described herein, including the detailed description that follows, the claims, as well as the appended drawings.

It is to be understood that both the foregoing general description and the following detailed description present embodiments, and are intended to provide an overview or framework for understanding the nature and character of the disclosure. The accompanying drawings are included to provide a further understanding, and are incorporated into and constitute a part of this specification. The drawings illustrate various embodiments, and together with the description serve to explain the principles and operation of the concepts disclosed.

### BRIEF DESCRIPTION OF THE FIGURES

FIG. 1 is a front perspective view of an exemplary fiber optic equipment rack with an installed exemplary 1-RU size chassis supporting high-density fiber optic modules to provide a given fiber optic connection density and bandwidth capability, according to one embodiment;

FIG. 2 is a rear perspective close-up view of the chassis of FIG. 1 with fiber optic modules installed in fiber optic equipment trays installed in the fiber optic equipment;

FIG. 3 is a front perspective view of one fiber optic equipment tray with installed fiber optic modules configured to be installed in the chassis of FIG. 1;

FIG. 4 is a close-up view of the fiber optic equipment tray of FIG. 3 without fiber optic modules installed;

FIG. 5 is a close-up view of the fiber optic equipment tray of FIG. 3 with fiber optic modules installed;

FIG. 6 is a front perspective view of the fiber optic equipment tray of FIG. 3 without fiber optic modules installed;

FIG. 7 is a front perspective view of fiber optic equipment trays supporting fiber optic modules with one fiber optic equipment tray extended out from the chassis of FIG. 1;

FIG. 8 is a left perspective view of an exemplary tray guide disposed in the chassis of FIG. 1 configured to receive fiber optic equipment trays of FIG. 6 capable of supporting one or more fiber optic modules;

FIGS. 9A and 9B are perspective and top views, respectively, of an exemplary tray rail disposed on each side of the fiber optic equipment tray of FIG. 3 and configured to be received in the chassis of FIG. 1 by the tray guide of FIG. 8;

FIGS. 10A and 10B are front right and left perspective views, respectively, of an exemplary fiber optic module that can be disposed in the fiber optic equipment trays of FIG. 3;

FIG. 11 is a perspective, exploded view of the fiber optic module in FIGS. 10A and 10B;

FIG. 12 is a perspective top view of the fiber optic module of FIG. 11 with the cover removed and showing a fiber optic harness installed therein;

FIG. 13 is a front view of the fiber optic module of FIG. 11 without fiber optic components installed;

FIG. 14 is a front right perspective view of another alternate fiber optic module that supports twelve (12) fiber MPO fiber optic components and which can be installed in the fiber optic equipment tray of FIG. 3;

FIG. 15 is front right perspective view of another alternate fiber optic module that supports twenty-four (24) fiber MPO fiber optic components and which can be installed in the fiber optic equipment tray of FIG. 3;

FIG. 16 is a front perspective view of an alternate fiber optic module being installed in the fiber optic equipment tray of FIG. 3;

FIG. 17 is front right perspective view of the fiber optic module of FIG. 16;

FIG. 18 is a front view of the fiber optic module of FIGS. 16 and 17;

FIG. 19 is a front perspective view of another alternate fiber optic module being installed in the fiber optic equipment tray of FIG. 3;

FIG. 20 is front right perspective view of the fiber optic module of FIG. 19;

FIG. 21 is a front view of the fiber optic module of FIGS. 19 and 20;

FIG. 22 is a front perspective view of another alternate fiber optic module being installed in an alternate fiber optic equipment tray that can be installed in the chassis of FIG. 1;

FIGS. 23 is front right perspective view of the fiber optic module of FIG. 22;

FIG. 24 is a front view of the fiber optic module of FIGS. 22 and 23;

FIG. 25 is a front perspective view of alternate exemplary 4-U size fiber optic chassis that can support the fiber optic equipment trays and fiber optic modules according to the fiber optic equipment tray and fiber optic modules disclosed; and

FIGS. 26-32 illustrate embodiments of a transition panel and/or module with one or more MPO adapters.

### DETAILED DESCRIPTION OF THE EMBODIMENTS

Reference will now be made in detail to certain embodiments, examples of which are illustrated in the accompanying drawings, in which some, but not all features are shown. Indeed, embodiments disclosed herein may be embodied in many different forms and should not be construed as limited to the embodiments set forth herein; rather, these embodiments are provided so that this disclosure will satisfy applicable legal requirements. Whenever possible, like reference numbers will be used to refer to like components or parts.

Embodiments disclosed in the detailed description include high-density fiber optic modules and fiber optic module housings and related equipment. In certain embodiments, the width and/or height of the front opening of fiber optic modules and/or fiber optic module housings can be provided according to a designed relationship to the width and/or height, respectively, of a front side of the main body of the fiber optic modules and fiber optic module housings to support fiber optic components or connections. In this manner, fiber optic components can be installed in a given percentage or area of the front side of the fiber optic module to provide a high density of fiber optic connections for a given fiber optic component type(s). In another embodiment, the front openings of the fiber optic modules and/or fiber optic module housings can be provided to support a designed connection density of fiber optic components or connections for a given width and/or height of the front opening of the fiber optic module and/or fiber optic module housing. Embodiments disclosed in the detailed description also include high connection density and bandwidth fiber optic apparatuses and related equipment. In certain embodiments, fiber optic apparatuses are provided and comprise a chassis defining one or more U space fiber optic equipment units, wherein at least one of the one or more U space fiber optic equipment units is configured to support a given fiber optic connection density or bandwidth in a 1-U space, and for a given fiber optic component type(s).

Embodiments disclosed in the detailed description also include there is provided a fiber optic apparatus comprising a fiber optic equipment rack. The fiber optic equipment rack defines at least one 1-U space fiber optic equipment unit configured to hold fiber optic equipment. A fiber optic panel is movably positioned in the fiber optic equipment. The fiber optic panel is configured to hold at least one adapter for temporarily receiving a connector from a fiber optic cable, such that the fiber optic cable is parked until moved to another location.

Further, as used herein, it is intended that the terms “fiber optic cables” and/or “optical fibers” include all types of single mode and multi-mode light waveguides, including one or more bare optical fibers, loose-tube optical fibers, tight-buffered optical fibers, ribbonized optical fibers, bend-insensitive optical fibers, or any other expedient of a medium for transmitting light signals.

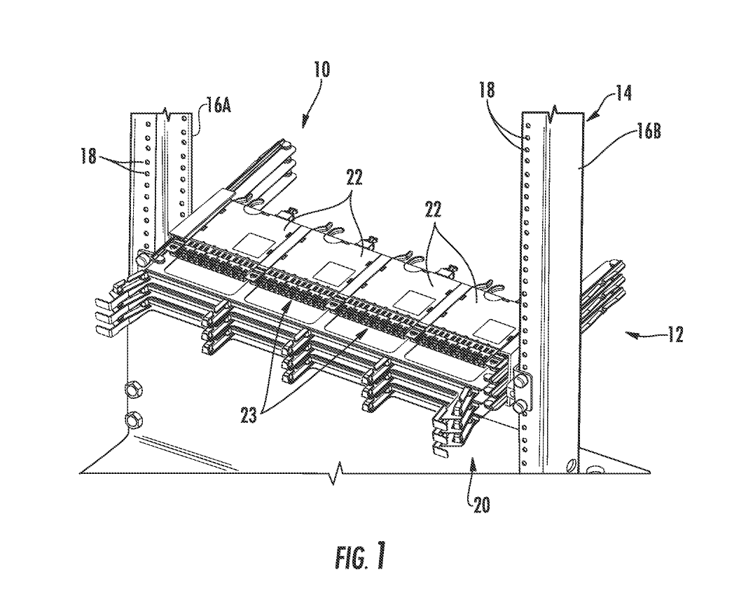

In this regard, FIG. 1 illustrates exemplary 1-U size fiber optic equipment 10 from a front perspective view. The fiber optic equipment 10 supports high-density fiber optic modules that support a high fiber optic connection density and bandwidth in a 1-U space, as will be described in greater detail below. The fiber optic equipment 10 may be provided at a data distribution center or central office to support cable-to-cable fiber optic connections and to manage a plurality of fiber optic cable connections. As will be described in greater detail below, the fiber optic equipment 10 has one or more fiber optic equipment trays that each support one or more fiber optic modules. However, the fiber optic equipment 10 could also be adapted to support one or more fiber optic patch panels or other fiber optic equipment that supports fiber optic components and connectivity.

The fiber optic equipment 10 includes a fiber optic equipment chassis 12 (“chassis 12”). The chassis 12 is shown as being installed in a fiber optic equipment rack 14. The fiber optic equipment rack 14 contains two vertical rails 16A, 16B that extend vertically and include a series of apertures 18 for facilitating attachment of the chassis 12 inside the fiber optic equipment rack 14. The chassis 12 is attached and supported by the fiber optic equipment rack 14 in the form of shelves that are stacked on top of each other within the vertical rails 16A, 16B. As illustrated, the chassis 12 is attached to the vertical rails 16A, 16B. The fiber optic equipment rack 14 may support 1-RU-sized shelves, with “U” equal to a standard 1.75 inches in height and nineteen (19) inches in width. In certain applications, the width of “U” may be twenty-three (23) inches. Also, the term fiber optic equipment rack 14 should be understood to include structures that are cabinets as well. In this embodiment, the chassis 12 is 1-U in size; however, the chassis 12 could be provided in a size greater than 1-U as well.

As will be discussed in greater detail later below, the fiber optic equipment 10 includes a plurality of extendable fiber optic equipment trays 20 that each carries one or more fiber optic modules 22. The chassis 12 and fiber optic equipment trays 20 support fiber optic modules 22 that support high-density fiber optic modules and a fiber optic connection density and bandwidth connections in a given space, including in a 1-U space. FIG. 1 shows exemplary fiber optic components 23 disposed in the fiber optic modules 22 that support fiber optic connections. For example, the fiber optic components 23 may be fiber optic adapters or fiber optic connectors. As will also be discussed in greater detail later below, the fiber optic modules 22 in this embodiment can be provided such that the fiber optic components 23 can be disposed through at least eighty-five percent (85%) of the width of the front side or face of the fiber optic module 22, as an example. This fiber optic module 22 configuration may provide a front opening of approximately 90 millimeters (mm) or less wherein fiber optic components can be disposed through the front opening and at a fiber optic connection density of at least one fiber optic connection per 7.0 mm of width of the front opening of the fiber optic modules 22 for simplex or duplex fiber optic components 23. In this example, six (6) duplex or twelve (12) simplex fiber optic components may be installed in each fiber optic module 22. The fiber optic equipment trays 20 in this embodiment support up to four (4) of the fiber optic modules 22 in approximately the width of a 1-U space, and three (3) fiber optic equipment trays 20 in the height of a 1-U space for a total of twelve (12) fiber optic modules 22 in a 1-U space. Thus, for example, if six (6) duplex fiber optic components were disposed in each of the twelve (12) fiber optic modules 22 installed in fiber optic equipment trays 20 of the chassis 12 as illustrated in FIG. 1, a total of one hundred forty-four (144) fiber optic connections, or seventy-two (72) duplex channels (i.e., transmit and receive channels), would be supported by the chassis 12 in a 1-U space. If five (5) duplex fiber optic adapters are disposed in each of the twelve (12) fiber optic modules 22 installed in fiber optic equipment trays 20 of the chassis 12, a total of one hundred twenty (120) fiber optic connections, or sixty (60) duplex channels, would be supported by the chassis 12 in a 1-U space. The chassis 12 also supports at least ninety-eight (98) fiber optic components in a 1-U space wherein at least one of the fiber optic components is a simplex or duplex fiber optic component.

If multi-fiber fiber optic components were installed in the fiber optic modules 22, such as MPO components for example, higher fiber optic connection density and bandwidths would be possible over other chassis 12 that use similar fiber optic components. For example, if up to four (4) twelve (12) fiber MPO fiber optic components were disposed in each fiber optic module 22, and twelve (12) of the fiber optic modules 22 were disposed in the chassis 12 in a 1-U space, the chassis 12 would support up to five hundred seventy-six (576) fiber optic connections in a 1-U space. If up to four (4) twenty-four (24) fiber MPO fiber optic components were disposed in each fiber optic module 22, and twelve (12) of the fiber optic modules 22 were disposed in the chassis 12, up to one thousand one hundred fifty-two (1152) fiber optic connections in a 1-U space.

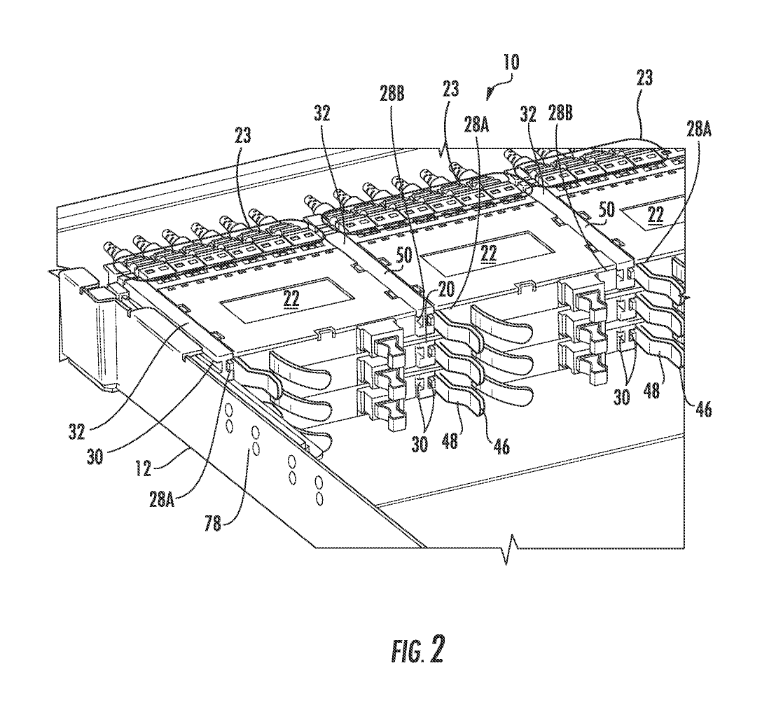

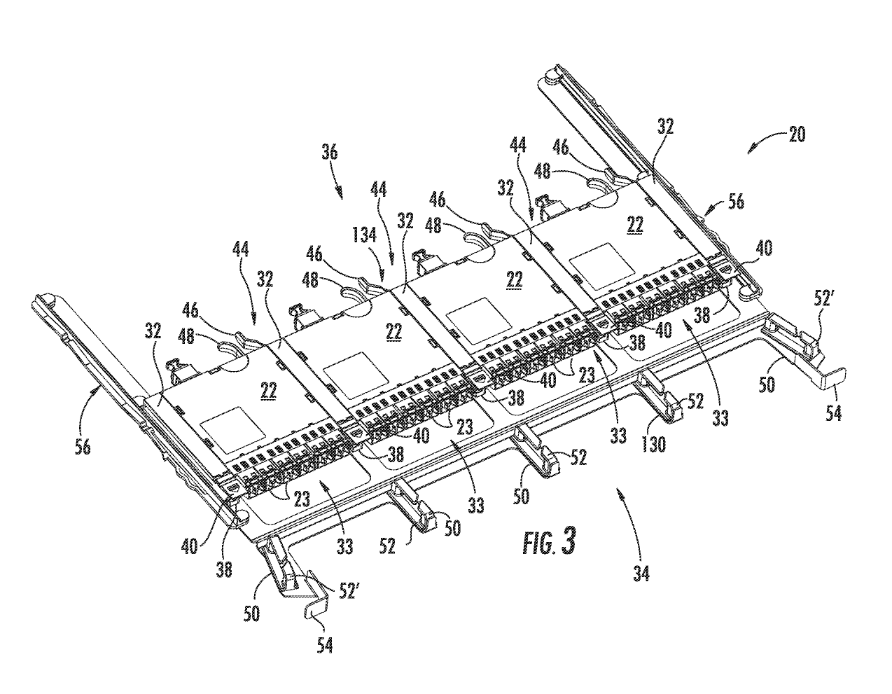

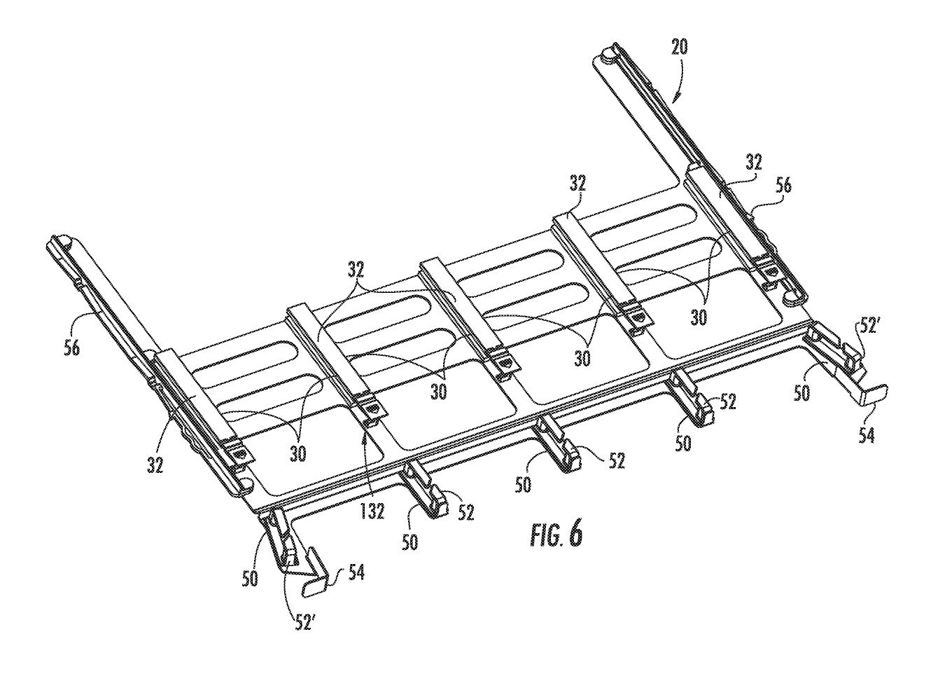

FIG. 2 is a rear perspective close-up view of the chassis 12 of FIG. 1 with fiber optic modules 22 loaded with fiber optic components 23 and installed in fiber optic equipment trays 20 installed in the chassis 12. Module rails 28A, 28B are disposed on each side of each fiber optic module 22. The module rails 28A, 28B are configured to be inserted within tray channels 30 of module rail guides 32 disposed in the fiber optic equipment tray 20, as illustrated in more detail in FIGS. 3-5. Note that any number of module rail guides 32 can be provided. The fiber optic module 22 can be installed from both a front end 34 and a rear end 36 of the fiber optic equipment tray 20 in this embodiment. If it is desired to install the fiber optic module 22 in the fiber optic equipment tray 20 from the rear end 36, a front end 33 of the fiber optic module 22 can be inserted from the rear end 36 of the fiber optic equipment tray 20. More specifically, the front end 33 of the fiber optic module 22 is inserted into the tray channels 30 of the module rail guides 32. The fiber optic module 22 can then be pushed forward within the tray channels 30 until the fiber optic module 22 reaches the front end 34 of the module rail guides 32. The fiber optic modules 22 can be moved towards the front end 34 until the fiber optic modules 22 reach a stop or locking feature disposed in the front end 34 as will described later in this application. FIG. 6 also illustrates the fiber optic equipment tray 20 without installed fiber optic modules 22 to illustrate the tray channels 30 and other features of the fiber optic equipment tray 20.

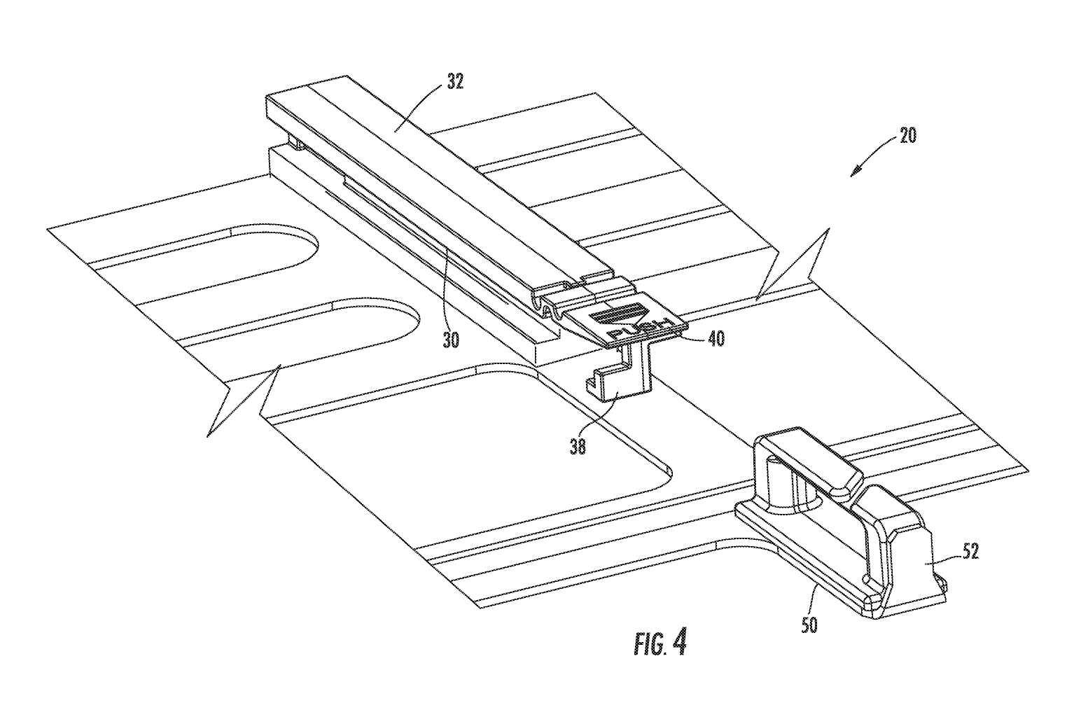

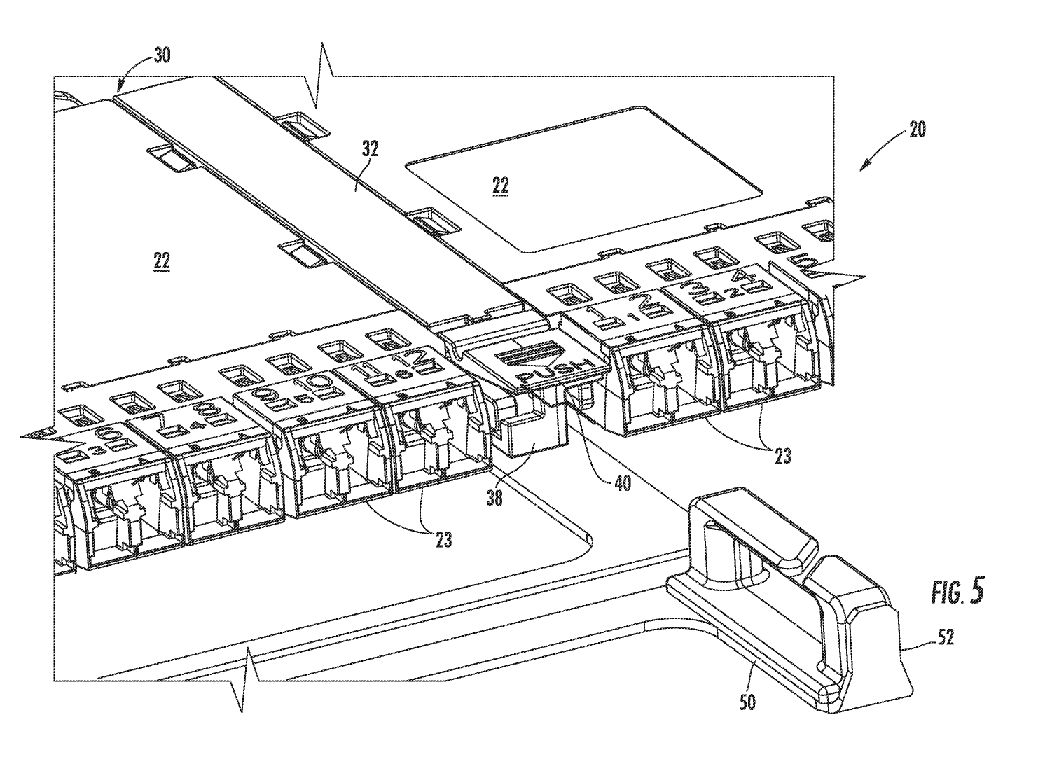

The fiber optic module 22 can be locked into place in the fiber optic equipment tray 20 by pushing the fiber optic module 22 forward to the front end 33 of the fiber optic equipment tray 20. A locking feature in the form of a front stop 38 is disposed in the module rail guides 32, as illustrated in FIG. 3 and in more detail in the close-up view in FIG. 4. The front stop 38 prevents the fiber optic module 22 from extending beyond the front end 34, as illustrated in the close-up view of the fiber optic equipment tray 20 with installed fiber optic modules 22 in FIG. 5. When it is desired to remove a fiber optic module 22 from the fiber optic equipment tray 20, a front module tab 40 also disposed in the module rail guides 32 and coupled to the front stop 38 can be pushed downward to engage the front stop 38. As a result, the front stop 38 will move outward away from the fiber optic module 22 such that the fiber optic module 22 is not obstructed from being pulled forward. The fiber optic module 22, and in particular its module rails 28A, 28B (FIG. 2), can be pulled forward along the module rail guides 32 to remove the fiber optic module 22 from the fiber optic equipment tray 20.

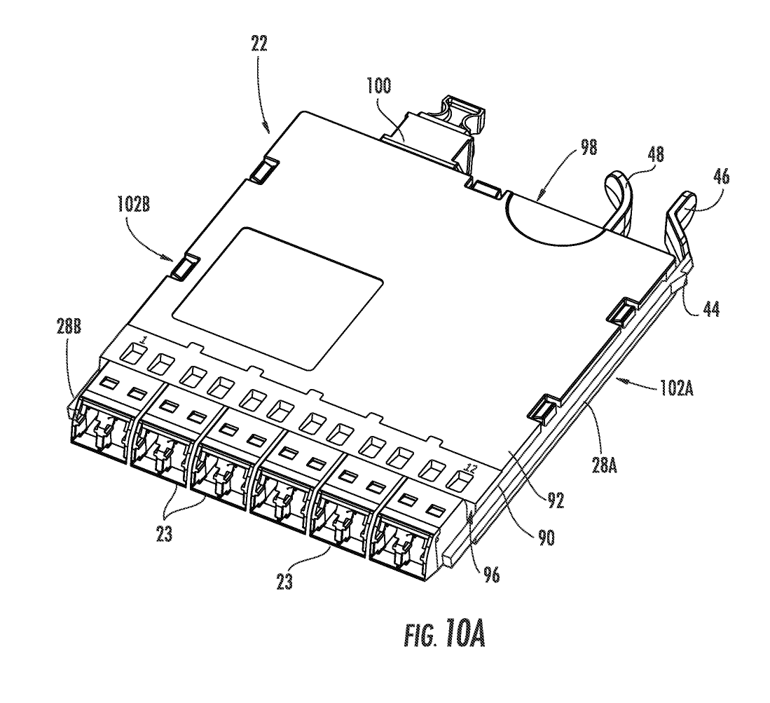

The fiber optic module 22 can also be removed from the rear end 36 of the fiber optic equipment tray 20. To remove the fiber optic module 22 from the rear end 36 of the fiber optic equipment tray 20, a latch 44 is disengaged by pushing a lever 46 (see FIGS. 2 and 3; see also, FIGS. 10A and 10B) inward towards the fiber optic module 22 to release the latch 44 from the module rail guide 32. To facilitate pushing the lever 46 inward towards the fiber optic module 22, a finger hook 48 is provided adjacent to the lever 46 so the lever 46 can easily be squeezed into the finger hook 48 by a thumb and index finger.

With continuing reference to FIG. 3-6, the fiber optic equipment tray 20 may also contain extension members 50. Routing guides 52 may be conveniently disposed on the extension members 50 to provide routing for optical fibers or fiber optic cables connected to fiber optic components 23 disposed in the fiber optic modules 22 (FIG. 3). The routing guides 52′ on the ends of the fiber optic equipment tray 20 may be angled with respect to the module rail guides 32 to route optical fibers or fiber optic cables at an angle to the sides of the fiber optic equipment tray 20. Pull tabs 54 may also be connected to the extension members 50 to provide a means to allow the fiber optic equipment tray 20 to easily be pulled out from and pushed into the chassis 12.

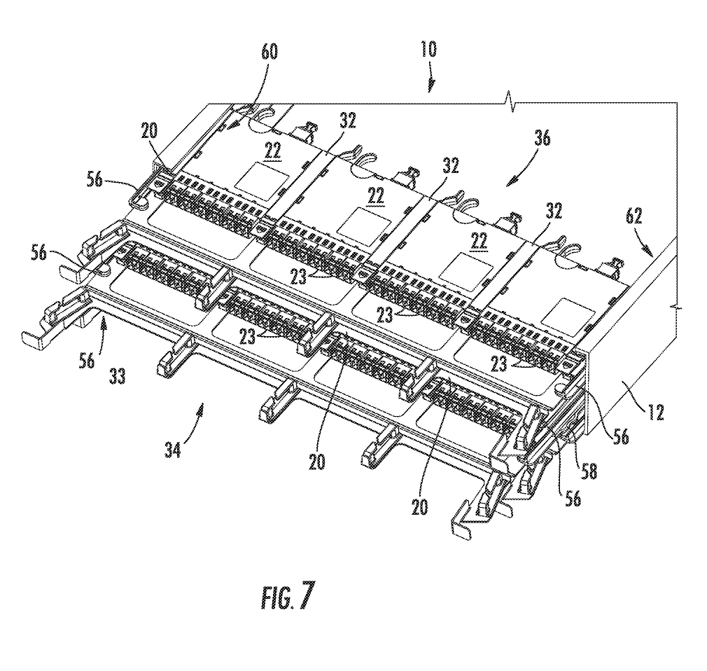

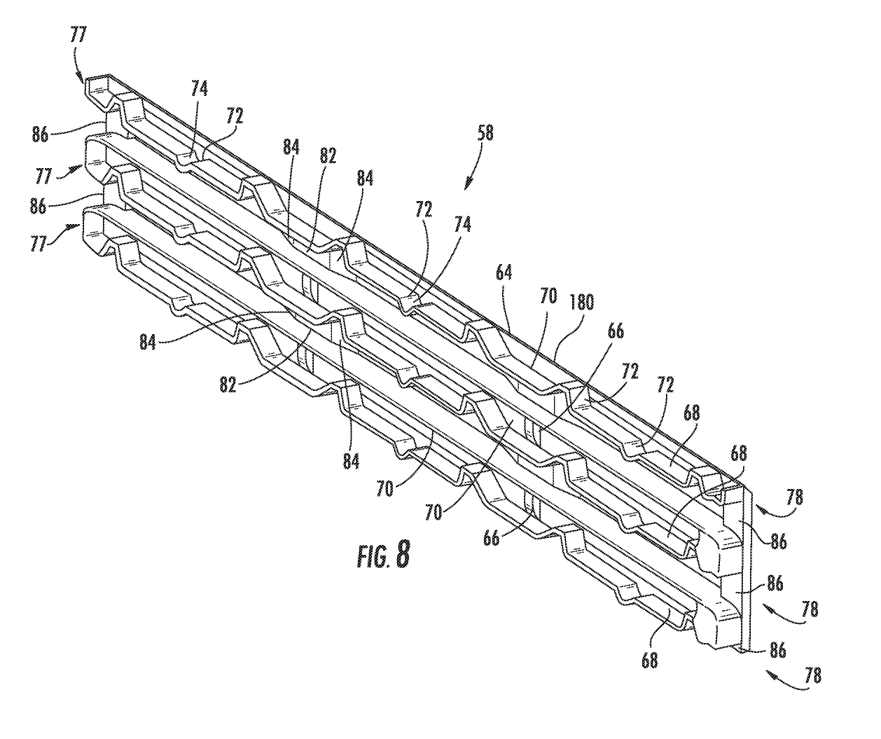

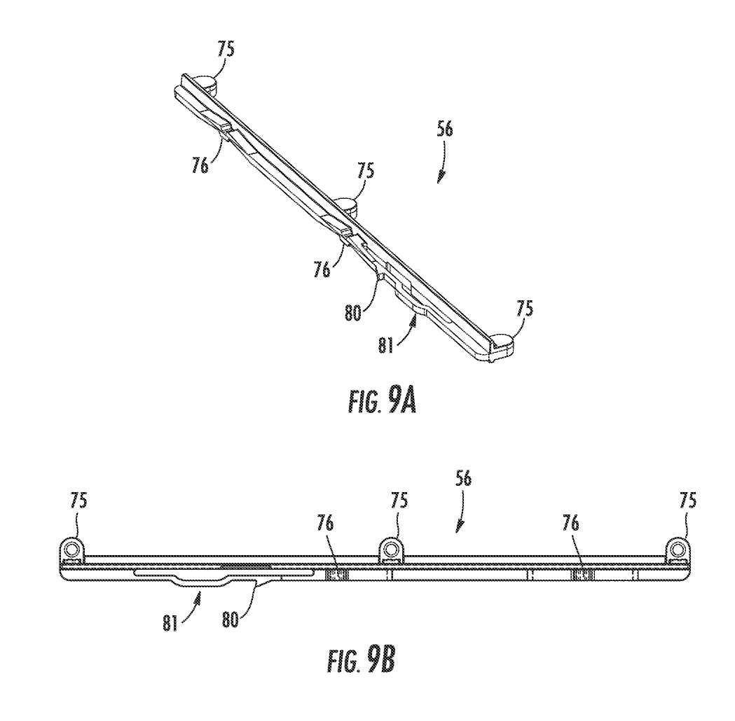

As illustrated in FIGS. 3 and 6, the fiber optic equipment tray 20 also contains tray rails 56. The tray rails 56 are configured to be received in tray guides 58 disposed in the chassis 12 to retain and allow the fiber optic equipment trays 20 to move in and out of the chassis 12, as illustrated in FIG. 7. More detail regarding the tray rails 56 and their coupling to the tray guides 58 in the chassis 12 is discussed below with regard to FIGS. 8 and 9A-9B. The fiber optic equipment trays 20 can be moved in and out of the chassis 12 by their tray rails 56 moving within the tray guides 58. In this manner, the fiber optic equipment trays 20 can be independently movable about the tray guides 58 in the chassis 12. FIG. 7 illustrates a front perspective view of one fiber optic equipment tray 20 pulled out from the chassis 12 among three (3) fiber optic equipment trays 20 disposed within the tray guides 58 of the chassis 12. The tray guides 58 may be disposed on both a left side end 60 and a right side end 62 of the fiber optic equipment tray 20. The tray guides 58 are installed opposite and facing each other in the chassis 12 to provide complementary tray guides 58 for the tray rails 56 of the fiber optic equipment trays 20 received therein. If it is desired to access a particular fiber optic equipment tray 20 and/or a particular fiber optic module 22 in a fiber optic equipment tray 20, the pull tab 54 of the desired fiber optic equipment tray 20 can be pulled forward to cause the fiber optic equipment tray 20 to extend forward out from the chassis 12, as illustrated in FIG. 7. The fiber optic module 22 can be removed from the fiber optic equipment tray 20 as previously discussed. When access is completed, the fiber optic equipment tray 20 can be pushed back into the chassis 12 wherein the tray rails 56 move within the tray guides 58 disposed in the chassis 12.

FIG. 8 is a left perspective view of an exemplary tray guide 58 disposed in the chassis 12 of FIG. 1. As discussed above, the tray guides 58 are configured to receive fiber optic equipment trays 20 supporting one or more fiber optic modules 22 in the chassis 12. The tray guides 58 allow the fiber optic equipment trays 20 to be pulled out from the chassis 12, as illustrated in FIG. 7. The tray guide 58 in this embodiment is comprised of a guide panel 64. The guide panel 64 may be constructed out of any material desired, including but not limited to a polymer or metal. The guide panel 64 contains a series of apertures 66 to facilitate attachment of the guide panel 64 to the chassis 12, as illustrated in FIG. 8. Guide members 68 are disposed in the guide panel 64 and configured to receive the tray rail 56 of the fiber optic equipment tray 20. Three (3) guide members 68 are disposed in the guide panel 64 in the embodiment of FIG. 8 to be capable of receiving up to three (3) tray rails 56 of three (3) fiber optic equipment trays 20 in a 1-U space. However, any number of guide members 68 desired may be provided in the tray guide 58 to cover sizes less than or greater than a 1-RU space. In this embodiment, the guide members 68 each include guide channels 70 configured to receive and allow tray rails 56 to move along the guide channels 70 for translation of the fiber optic equipment trays 20 about the chassis 12.

Leaf springs 72 are disposed in each of the guide members 68 of the tray guide 58 and are each configured to provide stopping positions for the tray rails 56 during movement of the fiber optic equipment tray 20 in the guide members 68. The leaf springs 72 each contain detents 74 that are configured to receive protrusions 76 (FIG. 9A-9D) disposed in the tray rails 56 to provide stopping or resting positions. The tray rails 56 contain mounting platforms 75 that are used to attach the tray rails 56 to the fiber optic equipment trays 20. It may be desirable to provide stopping positions in the tray guide 56 to allow the fiber optic equipment trays 20 to have stopping positions when moved in and out of the chassis 12. Two (2) protrusions 76 in the tray rail 56 are disposed in two (2) detents 74 in the tray guide 58 at any given time. When the fiber optic equipment tray 20 is fully retracted into the chassis 12 in a first stopping position, the two (2) protrusions 76 of the tray rail 56 are disposed in the one detent 74 adjacent a rear end 77 of the guide channel 70 and the middle detent 74 disposed between the rear end 77 and a front end 78 of the guide channel 70. When the fiber optic equipment tray 20 is pulled out from the chassis 12, the two (2) protrusions 76 of the tray rail 56 are disposed in the one detent 74 adjacent the front end 78 of the guide channel 70 and the middle detent 74 disposed between the rear end 77 and the front end 78 of the guide channel 70.

As the tray rail 56 is pulled within the guide channel 70, a protrusion 80 disposed in the tray rail 56 and illustrated in FIGS. 9A and 9B is biased to pass over transition members 82 disposed between the leaf springs 72, as illustrated in FIG. 8. The protrusion 80 is provided in a leaf spring 81 disposed in the tray rail 56, as illustrated in FIGS. 9A and 9B. The transition members 82 have inclined surfaces 84 that allow the protrusion 80 to pass over the transition members 82 as the fiber optic equipment tray 20 is being translated with the guide channel 70. As the protrusion 80 contains the transition members 82, the force imparted onto the protrusion 80 causes the leaf spring 81 to bend inward to allow the protrusion 80 to pass over the transition member 82. To prevent the tray rail 56 and thus the fiber optic equipment tray 20 from being extended beyond the front end 78 and rear end 77 of the guide channel 70, stopping members 86 are disposed at the front end 78 and rear end 77 of the guide channel 70. The stopping members 86 do not have an inclined surface; thus the protrusion 80 in the tray rail 56 abuts against the stopping member 86 and is prevented from extending over the stopping member 86 and outside of the front end 78 of the guide channel 70.

Against the background of the above disclosed embodiment of a 1-U chassis 12 and fiber optic equipment trays 20 and fiber optic modules 22 that can installed therein, the form factor of the fiber optic module 22 will now be described. The form factor of the fiber optic module 22 allows a high density of fiber optic components 23 to be disposed within a certain percentage area of the front of the fiber optic module 22 thus supporting a particular fiber optic connection density and bandwidth for a given type of fiber optic component 23. When this fiber optic module 22 form factor is combined with the ability to support up to twelve (12) fiber optic modules 22 in a 1-U space, as described by the exemplary chassis 12 example above, a higher fiber optic connection density and bandwidth is supported and possible.

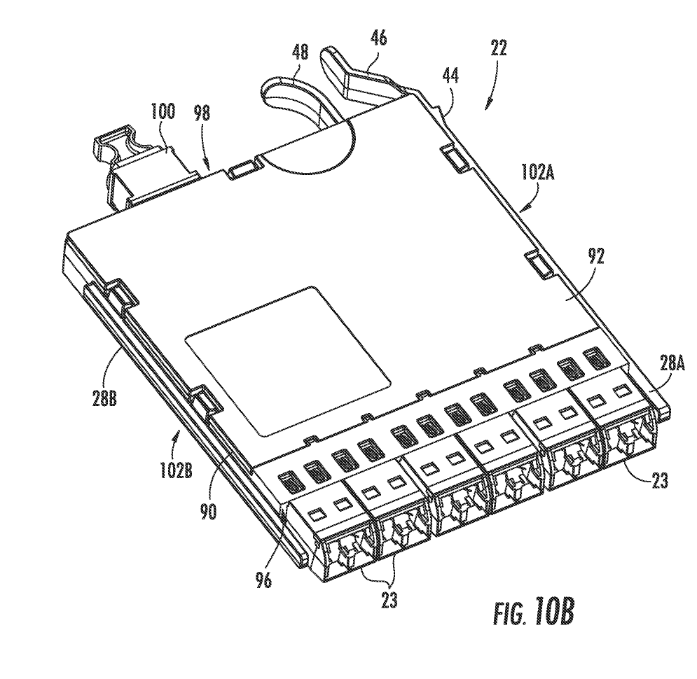

In this regard, FIGS. 10A and 10B are right and left perspective views of the exemplary fiber optic module 22. As discussed above, the fiber optic module 22 can be installed in the fiber optic equipment trays 20 to provide fiber optic connections in the chassis 12. The fiber optic module 22 is comprised of a main body 90 receiving a cover 92. An internal chamber 94 (FIG. 11) disposed inside the main body 90 and the cover 92 and is configured to receive or retain optical fibers or a fiber optic cable harness, as will be described in more detail below. The main body 90 is disposed between a front side 96 and a rear side 98 of the main body 90. Fiber optic components 23 can be disposed through the front side 96 of the main body 90 and configured to receive fiber optic connectors connected to fiber optic cables (not shown). In this example, the fiber optic components 23 are duplex LC fiber optic adapters that are configured to receive and support connections with duplex LC fiber optic connectors. However, any fiber optic connection type desired can be provided in the fiber optic module 22. The fiber optic components 23 are connected to a fiber optic component 100 disposed through the rear side 98 of the main body 90. In this manner, a connection to the fiber optic component 23 creates a fiber optic connection to the fiber optic component 100. In this example, the fiber optic component 100 is a multi-fiber MPO fiber optic adapter equipped to establish connections to multiple optical fibers (e.g., either twelve (12) or twenty-four (24) optical fibers). The fiber optic module 22 may also manage polarity between the fiber optic components 23, 100.

The module rails 28A, 28B are disposed on each side 102A, 102B of the fiber optic module 22. As previously discussed, the module rails 28A, 28B are configured to be inserted within the module rail guides 32 in the fiber optic equipment tray 20, as illustrated in FIG. 3. In this manner, when it is desired to install a fiber optic module 22 in the fiber optic equipment tray 20, the front side 96 of the fiber optic module 22 can be inserted from either the front end 33 or the rear end 36 of the fiber optic equipment tray 20, as previously discussed.

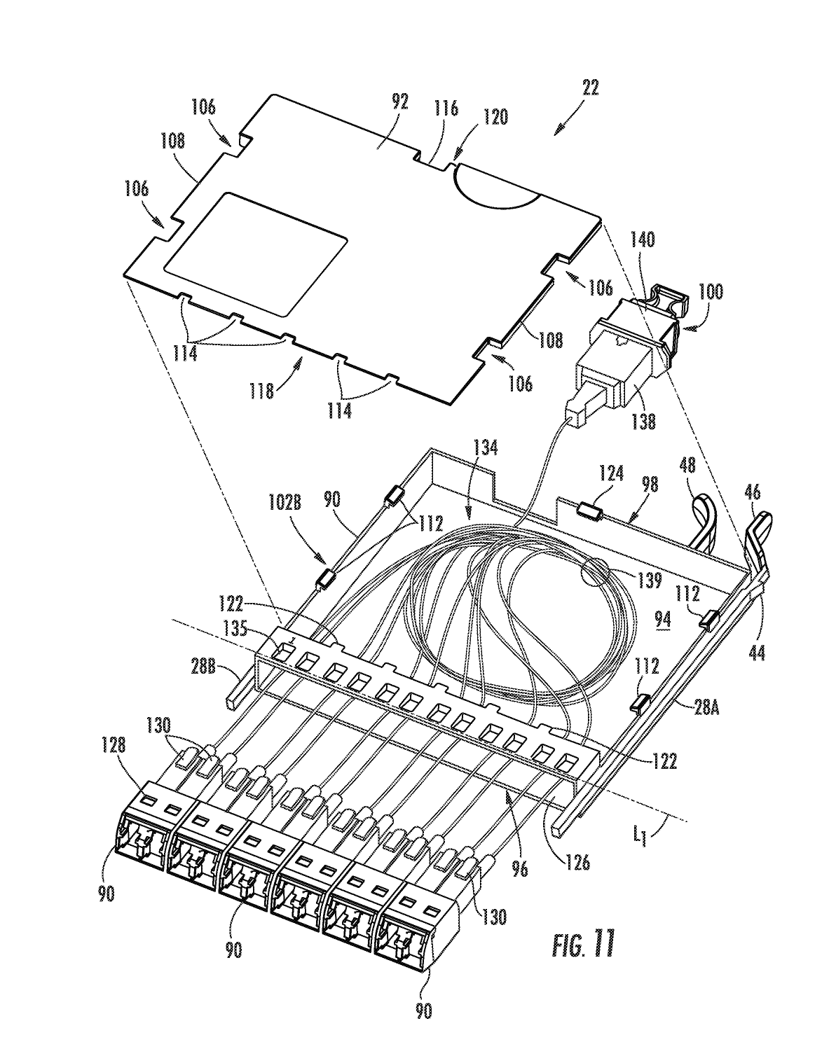

FIG. 11 illustrates the fiber optic module 22 in an exploded view with the cover 92 of the fiber optic module 22 removed to illustrate the internal chamber 94 and other internal components of the fiber optic module 22. FIG. 12 illustrates the fiber optic module 22 assembled, but without the cover 92 installed on the main body 90. The cover 92 includes notches 106 disposed in sides 108, 110 that are configured to interlock with protrusions 112 disposed on the sides 102A, 102B of the main body 90 of the fiber optic modules 22 when the cover 92 is attached to the main body 90 to secure the cover 92 to the main body 90. The cover 92 also contains notches 114, 116 disposed on a front side 118 and rear side 120, respectively, of the cover 92. The notches 114, 116 are configured to interlock with protrusions 122, 124 disposed in the front side 96 and the rear end 98, respectively, of the main body 90 when the cover 92 is attached to the main body 90 to also secure the cover 92 to the main body 90. FIG. 12 does not show protrusions 122, 124.

With continuing reference to FIG. 11, the fiber optic components 23 are disposed through a front opening 126 disposed along a longitudinal axis L₁ in the front side 96 of the main body 90. In this embodiment, the fiber optic components 23 are duplex LC adapters 128, which support single or duplex fiber connections and connectors. The duplex LC adapters 128 in this embodiment contain protrusions 130 that are configured to engage with orifices 135 disposed on the main body 90 to secure the duplex LC adapters 128 in the main body 90 in this embodiment. A cable harness 134 is disposed in the internal chamber 94 with fiber optic connectors 136, 138 disposed on each end of optical fibers 139 connected to the duplex LC adapters 128 and the fiber optic component 100 disposed in the rear side 98 of the main body 90. The fiber optic component 100 in this embodiment is a twelve (12) fiber MPO fiber optic adapter 140 in this embodiment. Two vertical members 142A, 142B are disposed in the internal chamber 94 of the main body 90, as illustrated in FIG. 12, to retain the looping of the optical fibers 139 of the cable harness 134. The vertical members 142A, 142B and the distance between are designed to provide a bend radius R in the optical fibers 139 no greater than forty (40) mm and preferably twenty-five (25) mm or less in this embodiment.

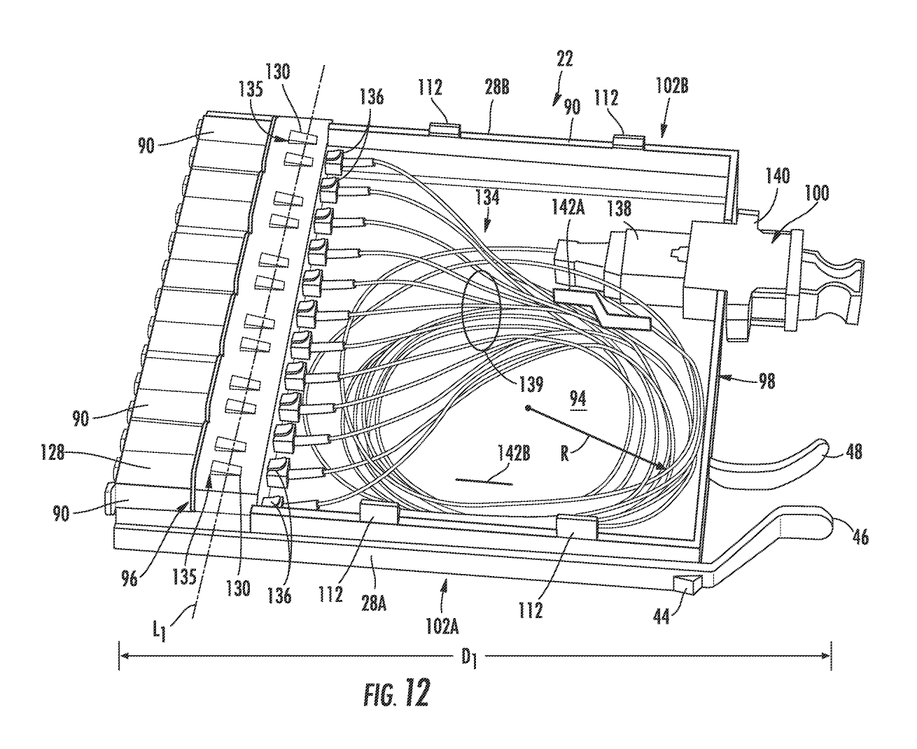

FIG. 13 illustrates a front view of the fiber optic module 22 without loaded fiber optic components 23 in the front side 96 to further illustrate the form factor of the fiber optic module 22. As previously discussed, the front opening 126 is disposed through the front side 96 of the main body 90 to receive the fiber optic components 23. The greater the width W₁ of the front opening 126, the greater the number of fiber optic components 23 that may be disposed in the fiber optic module 22. Greater numbers of fiber optic components 23 equates to more fiber optic connections, which supports higher fiber optic connectivity and bandwidth. However, the larger the width W₁ of the front opening 126, the greater the area required to be provided in the chassis 12 for the fiber optic module 22. Thus, in this embodiment, the width W₁ of the front opening 126 is design to be at least eighty-five percent (85%) of the width W₂ of the front side 96 of the main body 90 of the fiber optic module 22. The greater the percentage of the width W₁ to width W₂, the larger the area provided in the front opening 126 to receive fiber optic components 23 without increasing width W₂. Width W₃, the overall width of the fiber optic module 22, may be 86.6 mm or 3.5 inches in this embodiment. The overall depth D₁ of the fiber optic module 22 is 113.9 mm or 4.5 inches in this embodiment (FIG. 12). As previously discussed, the fiber optic module 22 is designed such that four (4) fiber optic modules 22 can be disposed in a 1-U width space in the fiber optic equipment tray 20 in the chassis 12. The width of the chassis 12 is designed to accommodate a 1-U space width in this embodiment.

With three (3) fiber optic equipment trays 20 disposed in the 1-U height of the chassis 12, a total of twelve (12) fiber optic modules 22 can be supported in a given 1-U space. Supporting up to twelve (12) fiber optic connections per fiber optic module 22 as illustrated in the chassis 12 in FIG. 1 equates to the chassis 12 supporting up to one hundred forty-four (144) fiber optic connections, or seventy-two (72) duplex channels, in a 1-U space in the chassis 12 (i.e., twelve (12) fiber optic connections multiplied by twelve (12) fiber optic modules 22 in a 1-U space). Thus, the chassis 12 is capable of supporting up to one hundred forty-four (144) fiber optic connections in a 1-U space by twelve (12) simplex or six (6) duplex fiber optic adapters being disposed in the fiber optic modules 22. Supporting up to ten (10) fiber optic connections per fiber optic module 22 equates to the chassis 12 supporting one hundred twenty (120) fiber optic connections, or sixty (60) duplex channels, in a 1-U space in the chassis 12 (i.e., ten (10) fiber optic connections X twelve (12) fiber optic modules 22 in a 1-U space). Thus, the chassis 12 is also capable of supporting up to one hundred twenty (120) fiber optic connections in a 1-U U space by ten (10) simplex or five (5) duplex fiber optic adapters being disposed in the fiber optic modules 22.

This embodiment of the chassis 12 and fiber optic module 22 disclosed herein can support a fiber optic connection density within a 1-U space wherein the area occupied by the fiber optic component 23 in twelve (12) fiber optic modules 22 in a 1-U space represents at least fifty percent (50%) of the total fiber optic equipment rack 14 area in a 1-U space (see FIG. 1). In the case of twelve (12) fiber optic modules 22 provided in a 1-U space in the chassis 12, the 1-U space is comprised of the fiber optic components 23 occupying at least seventy-five percent (75%) of the area of the front side 96 of the fiber optic module 22.

Two (2) duplexed optical fibers to provide one (1) transmission/reception pair can allow for a data rate of ten (10) Gigabits per second in half-duplex mode or twenty (20) Gigabits per second in full-duplex mode. Thus, with the above-described embodiment, providing at least seventy-two (72) duplex transmission and reception pairs in a 1-U space employing at least one duplex or simplex fiber optic component can support a data rate of at least seven hundred twenty (720) Gigabits per second in half-duplex mode in a 1-U space or at least one thousand four hundred forty (1440) Gigabits per second in a 1-U space in full-duplex mode if employing a ten (10) Gigabit transceiver. This configuration can also support at least six hundred (600) Gigabits per second in half-duplex mode in a 1-U space and at least one thousand two hundred (1200) Gigabits per second in full-duplex mode in a 1-U space, respectively, if employing a one hundred (100) Gigabit transceiver. This configuration can also support at least four hundred eighty (480) Gigabits per second in half-duplex mode in a 1-U space and nine hundred sixty (960) Gigabits per second in full duplex mode in a 1-U space, respectively, if employing a forty (40) Gigabit transceiver. At least sixty (60) duplex transmission and reception pairs in a 1-U space can allow for a data rate of at least six hundred (600) Gigabits per second in a 1-U space in half-duplex mode or at least one thousand two hundred (1200) Gigabits per second in a 1-U space in full-duplex mode when employing a ten (10) Gigabit transceiver. At least forty nine (49) duplex transmission and reception pairs in a 1-U space can allow for a data rate of at least four hundred eighty-one (481) Gigabits per second in half-duplex mode or at least nine hundred sixty-two (962)

Gigabits per second in a 1-U space in full-duplex mode when employing a ten (10) Gigabit transceiver.

The width W₁ of front opening 126 could be designed to be greater than eighty-five percent (85%) of the width W₂ of the front side 96 of the main body 90 of the fiber optic module 22. For example, the width W₁ could be designed to be between ninety percent (90%) and ninety-nine percent (99%) of the width W₂. As an example, the width W₁ could be less than ninety (90) mm. As another example, the width W₁ could be less than eighty-five (85) mm or less than eighty (80) mm. For example, the width W₁ may be eighty-three (83) mm and width W₂ may be eighty-five (85) mm, for a ratio of width W₁ to width W₂ of 97.6%. In this example, the front opening 126 may support twelve (12) fiber optic connections in the width W₁ to support a fiber optic connection density of at least one fiber optic connection per 7.0 mm of width W₁ of the front opening 126. Further, the front opening 126 of the fiber optic module 22 may support twelve (12) fiber optic connections in the width W₁ to support a fiber optic connection density of at least one fiber optic connection per 6.9 mm of width W₁ of the front opening 126.

Further as illustrated in FIG. 13, height H₁ of front opening 126 could be designed to be at least ninety percent (90%) of height H₂ of the front side 96 of the main body 90 of the fiber optic module 22. In this manner, the front opening 126 has sufficient height to receive the fiber optic components 23, and such that three (3) fiber optic modules 22 can be disposed in a 1-U space height. As an example, height H₁ could be twelve (12) mm or less or ten (10) mm or less. As an example, height H₁ could be ten (10) mm and height H₂ could be eleven (11) mm (or 7/16 inches), for a ratio of height H₁ to width H₂ of 90.9%.

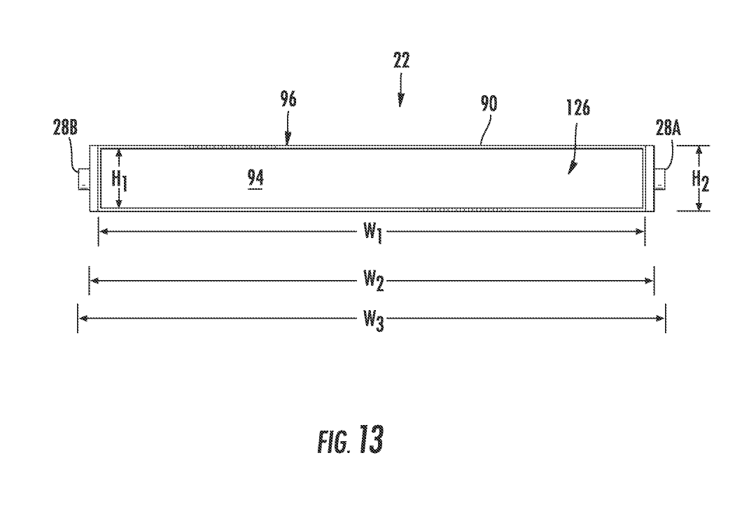

Alternate fiber optic modules with alternative fiber optic connection densities are possible. FIG. 14 is a front perspective view of an alternate fiber optic module 22′ that can be installed in the fiber optic equipment tray 20 of FIG. 1. The form factor of the fiber optic module 22′ is the same as the form factor of the fiber optic module 22 illustrated in FIGS. 1-13. However, in the fiber optic module 22′ of FIG. 14, two (2) MPO fiber optic adapters 150 are disposed through the front opening 126 of the fiber optic module 22′. The MPO fiber optic adapters 150 are connected to two (2) MPO fiber optic adapters 152 disposed in the rear side 98 of the main body 90 of the fiber optic module 22′. Thus, if the MPO fiber optic adapters 150 each support twelve (12) fibers, the fiber optic module 22′ can support up to twenty-four (24) fiber optic connections. Thus, in this example, if up to twelve (12) fiber optic modules 22′ are provided in the fiber optic equipment trays 20 of the chassis 12, up to two hundred eighty-eight (288) fiber optic connections can be supported by the chassis 12 in a 1-U space. Further in this example, the front opening 126 of the fiber optic module 22′ may support twenty-four (24) fiber optic connections in the width W₁ (FIG. 13) to support a fiber optic connection density of at least one fiber optic connection per 3.4-3.5 mm of width W₁ of the front opening 126. It should be understood that the discussion with regard to modules may also apply to a panel. For purposes of this disclosure, a panel may have one or more adapter on one side and no adapters on the opposite side.

Thus, with the above-described embodiment, providing at least two-hundred eighty-eight (288) duplex transmission and reception pairs in a 1-U space employing at least one twelve (12) fiber MPO fiber optic components can support a data rate of at least two thousand eight hundred eighty (2880) Gigabits per second in half-duplex mode in a 1-U space or at least five thousand seven hundred sixty (5760) Gigabits per second in a 1-U space in full-duplex mode if employing a ten (10) Gigabit transceiver. This configuration can also support at least four thousand eight hundred (4800) Gigabits per second in half-duplex mode in a 1-U space and nine thousand six hundred (9600) Gigabits per second in full-duplex mode in a 1-U space, respectively, if employing a one hundred (100) Gigabit transceiver. This configuration can also support at least one thousand nine hundred twenty (1920) Gigabits per second in half-duplex mode in a 1-U space and three thousand eight hundred forty (3840) Gigabits per second in full-duplex mode in a 1-U space, respectively, if employing a forty (40) Gigabit transceiver. This configuration also supports a data rate of at least four thousand three hundred twenty-two (4322) Gigabits per second in full-duplex mode in a 1-U space when employing a ten (10) Gigabit transceiver employing at least one twelve (12) fiber MPO fiber optic component, or two thousand one hundred sixty-one (2161) Gigabits per second in full-duplex mode in a 1-U space when employing a ten (10) Gigabit transceiver employing at least one twenty-four (24) fiber MPO fiber optic component.

If the MPO fiber optic adapters 150 in the fiber optic module 22′ support twenty-four (24) fibers, the fiber optic module 22′ can support up to forty-eight (48) fiber optic connections. Thus, in this example, if up to twelve (12) fiber optic modules 22′ are provided in the fiber optic equipment trays 20 of the chassis 12, up to five hundred seventy-six (576) fiber optic connections can be supported by the chassis 12 in a 1-U space if the fiber optic modules 22′ are disposed in the fiber optic equipment trays 20. Further, in this example, the front opening 126 of the fiber optic module 22′ may support up to forty-eight (48) fiber optic connections in the width W₁ to support a fiber optic connection density of at least one fiber optic connection per 1.7 mm of width W₁ of the front opening 126.

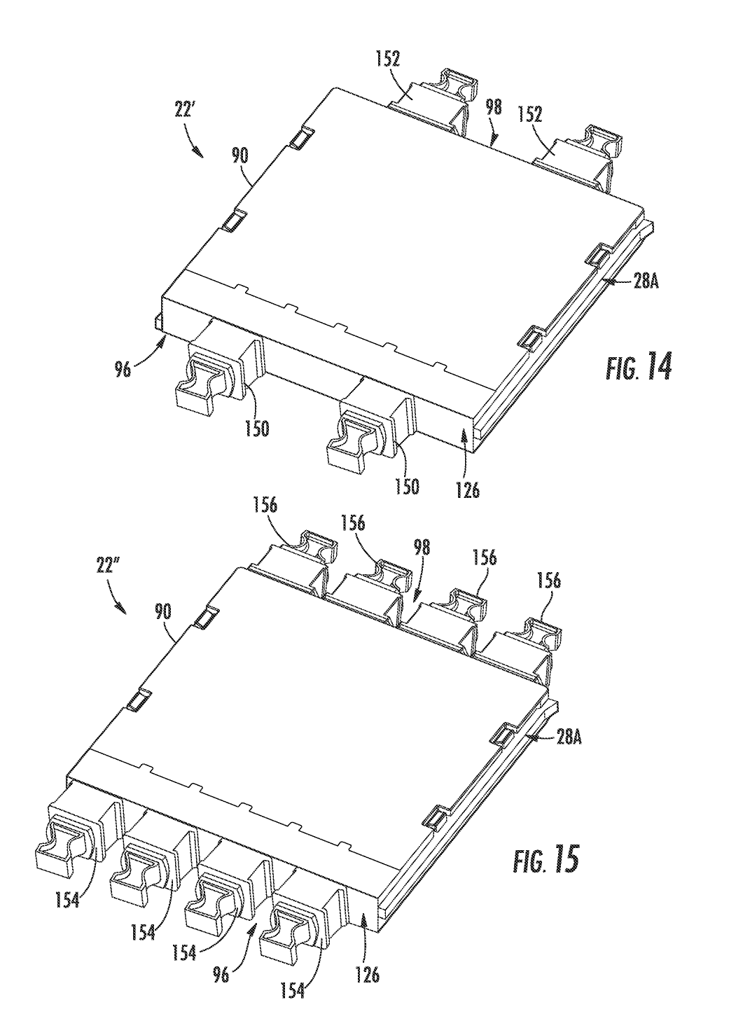

FIG. 15 is a front perspective view of another alternate fiber optic module 22″ that can be installed in the fiber optic equipment tray 20 of FIG. 1. The form factor of the fiber optic module 22″ is the same as the form factor of the fiber optic module 22 illustrated in FIGS. 1-13. However, in the fiber optic module 22″, four (4) MPO fiber optic adapters 154 are disposed through the front opening 126 of the fiber optic module 22″. The MPO fiber optic adapters 154 are connected to four (4) MPO fiber optic adapters 156 disposed in the rear end 98 of the main body 90 of the fiber optic module 22′. Thus, if the MPO fiber optic adapters 150 support twelve (12) fibers, the fiber optic module 22″ can support up to forty-eight (48) fiber optic connections. Thus, in this example, if up to twelve (12) fiber optic modules 22″ are provided in the fiber optic equipment trays 20 of the chassis 12, up to five hundred seventy-six (756) fiber optic connections can be supported by the chassis 12 in a 1-U space. Further in this example, the front opening 126 of the fiber optic module 22″ may support twenty-four (24) fiber optic connections in the width W₁ to support a fiber optic connection density of at least one fiber optic connection per 1.7 mm of width W₁ of the front opening 126.

If the four (4) MPO fiber optic adapters 154 disposed in the fiber optic module 22″ support twenty-four (24) fibers, the fiber optic module 22″ can support up to ninety-six (96) fiber optic connections. Thus, in this example, if up to twelve (12) fiber optic modules 22″ are provided in the fiber optic equipment trays 20 of the chassis 12, up to one thousand one hundred fifty-two (1152) fiber optic connections can be supported by the chassis 12 in a 1-U space. Further, in this example, the front opening 126 of the fiber optic module 22″ may support up to ninety-six (96) fiber optic connections in the width W₁ to support a fiber optic connection density of at least one fiber optic connection per 0.85 mm of width W₁ of the front opening 126.

Further, with the above-described embodiment, providing at least five hundred seventy-six (576) duplex transmission and reception pairs in a 1-U space employing at least one twenty-four (24) fiber MPO fiber optic component can support a data rate of at least five thousand seven hundred sixty (5760) Gigabits per second in half-duplex mode in a 1-U space or at least eleven thousand five hundred twenty (11520) Gigabits per second in a 1-U space in full-duplex mode if employing a ten (10) Gigabit transceiver. This configuration can also support at least four thousand eight hundred (4800) Gigabits per second in half-duplex mode in a 1-U space and at least nine thousand six hundred (9600) Gigabits per second in full-duplex mode in a 1-RU space, respectively, if employing a one hundred (100) Gigabit transceiver. This configuration can also support at least three thousand eight hundred forty (3840) Gigabits per second in half-duplex mode in a 1-U space and at least seven thousand six hundred eighty (7680) Gigabits per second in full-duplex mode in a 1-U space, respectively, if employing a forty (40) Gigabit transceiver. This configuration also supports a data rate of at least eight thousand six hundred forty two (8642) Gigabits per second in full-duplex mode in a 1-U space when employing a ten (10) Gigabit transceiver employing at least one twenty-four (24) fiber MPO fiber optic component, or four thousand three hundred twenty one (4321) Gigabits per second in full-duplex mode in a 1-U space when employing a ten (10) Gigabit transceiver employing at least one twenty-four (24) fiber MPO fiber optic component.

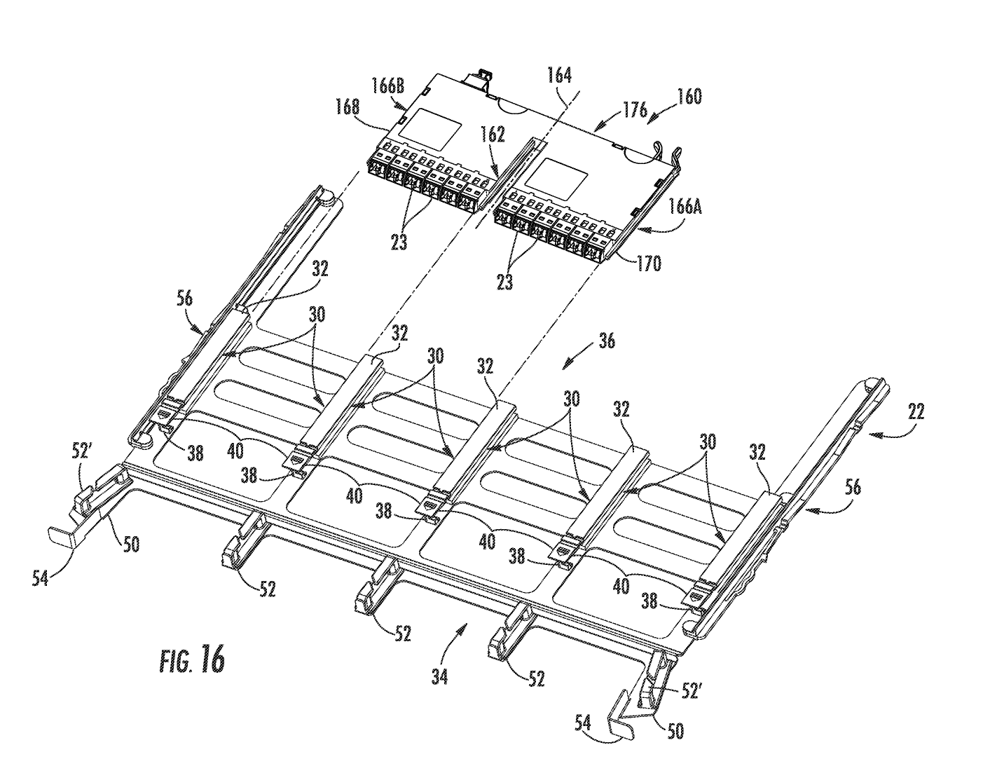

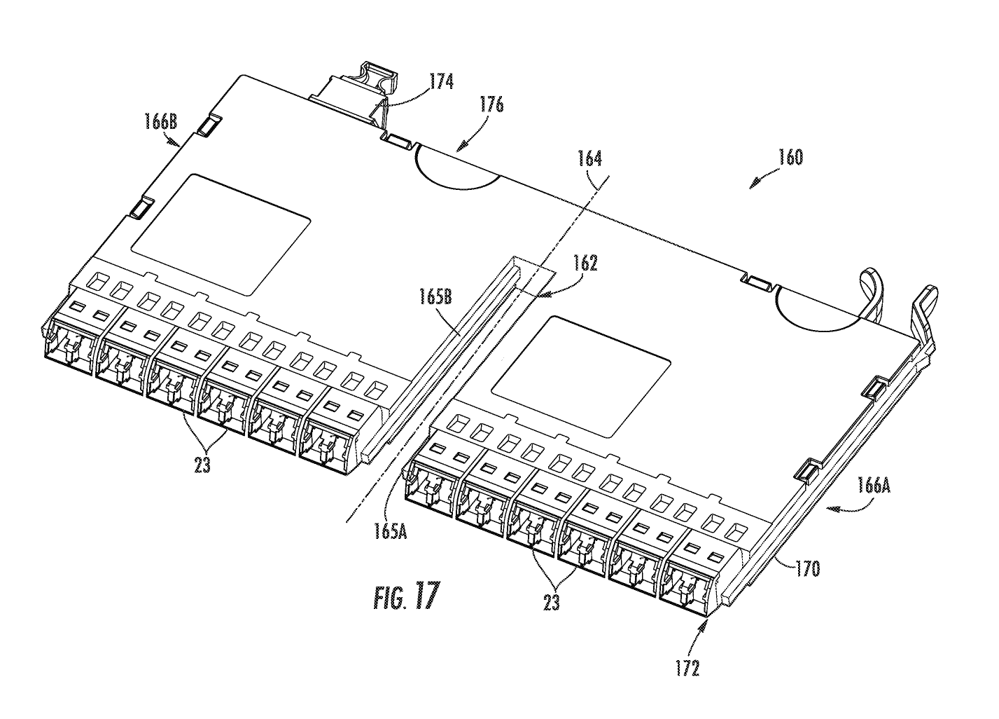

FIG. 16 illustrates an alternate fiber optic module 160 that may be provided in the fiber optic equipment trays 20 to support fiber optic connections and connection densities and bandwidths. FIG. 17 is a right front perspective view of the fiber optic module 160 of FIG. 16. In this embodiment, the fiber optic module 160 is designed to fit across two sets of module rail guides 32. A channel 162 is disposed through a center axis 164 of the fiber optic module 160 to receive a module rail guide 32 in the fiber optic equipment tray 20. Module rails 165A, 165B, similar to the module rails 28A, 28B of the fiber optic module 22 of FIGS. 1-13, are disposed on the inside the channel 162 of the fiber optic module 160 and configured to engage with tray channels 30 in the fiber optic equipment tray 20. Module rails 166A, 166B, similar to the module rails 28A, 28B of the fiber optic module 22 of FIGS. 1-13, are disposed on each side 168, 170 of the fiber optic module 160 that are configured to engage with tray channels 30 in the fiber optic equipment tray 20. The module rails 166A, 166B are configured to engage with tray channels 30 in a module rail guide 32 disposed between module rail guides 32 engaged with the module rail guides 32 disposed on the sides 168, 170 of the fiber optic module 160.

Up to twenty-four (24) fiber optic components 23 can be disposed in a front side 172 of the fiber optic module 160. In this embodiment, the fiber optic components 23 are comprised of up to twelve (12) duplex LC fiber optic adapters, which are connected to one twenty-four (24) fiber MPO fiber optic connector 174 disposed in a rear end 176 of the fiber optic module 160. Thus, with three (3) fiber optic equipment trays 20 disposed in the height of the chassis 12, a total of six (6) fiber optic modules 160 can be supported in a given 1-U space. Supporting up to twenty-four (24) fiber optic connections per fiber optic module 160 equates to the chassis 12 supporting up to one hundred forty-four (144) fiber optic connections, or seventy-two (72) duplex channels, in a 1-U space in the chassis 12 (i.e., twenty-four (24) fiber optic connections multiplied by six (6) fiber optic modules 160 in a 1-U space). Thus, the chassis 12 is capable of supporting up to one hundred forty-four (144) fiber optic connections in a 1-RU space by twenty-four (24) simplex or twelve (12) duplex fiber optic adapters being disposed in the fiber optic modules 160. Supporting up to twenty (20) fiber optic connections per fiber optic module 160 equates to the chassis 12 supporting one hundred twenty (120) fiber optic connections, or sixty (60) duplex channels, in a 1-U space in the chassis 12 (i.e., twenty (20) fiber optic connections multiplied by six (6) fiber optic modules 160 in a 1-U space). Thus, the chassis 12 is also capable of supporting up to one hundred twenty (120) fiber optic connections in a 1-U space by twenty (20) simplex or ten (10) duplex fiber optic adapters being disposed in the fiber optic modules 160.

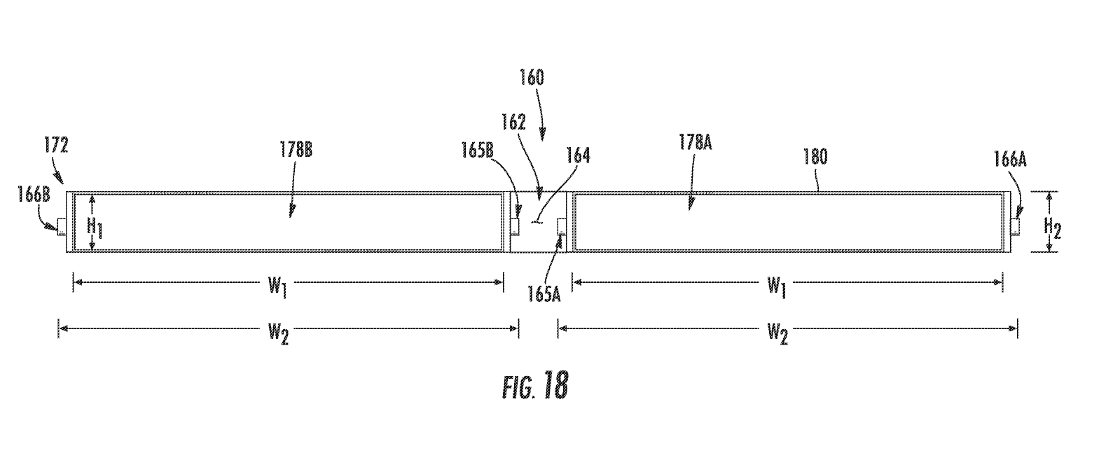

FIG. 18 illustrates a front view of the fiber optic module 160 of FIGS. 16-17 without loaded fiber optic components 23 in the front side 172 to further illustrate the form factor of the fiber optic module 160 in this embodiment. Front openings 178A, 178B disposed on each side of the channel 162 are disposed through the front side 172 of a main body 180 of the fiber optic module 160 to receive the fiber optic components 23. The widths W₁ and W₂ and the heights H₁ and H₂ are the same as in the fiber optic module 22 illustrated in FIG. 13. Thus, in this embodiment, the widths W₁ of front openings 178A, 178B are designed to be at least eighty-five percent (85%) of the width W₂ of the front side 172 of the main body 180 of the fiber optic module 160. The greater the percentage of the width W₁ to width W₂, the larger the area provided in the front openings 178A, 178B to receive fiber optic components 23 without increasing width W₂.

The width W₁ of the front openings 178A, 178B could each be designed to be greater than eighty-five percent (85%) of the width W₂ of the front side 172 of the main body 180 of the fiber optic module 160. For example, the width W₁ could be designed to be between ninety percent (90%) and ninety-nine percent (99%) of the width W₂. As an example, the width W₁ could be less than ninety (90) mm. As another example, the width W₁ could be less than eighty-five (85) mm or less than eighty (80) mm. For example, width W₁ may be eighty-three (83) mm and width W₂ may be eighty-five (85) mm, for a ratio of width W₁ to width W₂ of 97.6%. In this example, the front openings 178A, 178B may support twelve (12) fiber optic connections in the widths W₁ to support a fiber optic connection density of at least one fiber optic connection per 7.0 mm of width W₁ of the front openings 178A, 178B. Further, each of the front openings 178A, 178B may support twelve (12) fiber optic connections in the widths W₁ to support a fiber optic connection density of at least one fiber optic connection per 6.9 mm of width W₁ of the front openings 178A, 178B.

Further as illustrated in FIG. 18, the height H₁ of front openings 178A, 178B could be designed to be at least ninety percent (90%) of the height H₂ of the front side 172 of the main body 180 of the fiber optic module 160. In this manner, the front openings 178A, 178B have sufficient height to receive the fiber optic components 23, while three (3) fiber optic modules 160 can be disposed in the height of a 1-RU space. As an example, the height H₁ could be twelve (12) mm or less or ten (10) mm or less. As an example, the height H₁ could be ten (10) mm and height H₂ could be eleven (11) mm, for a ratio of height H₁ to height H₂ of 90.9%.

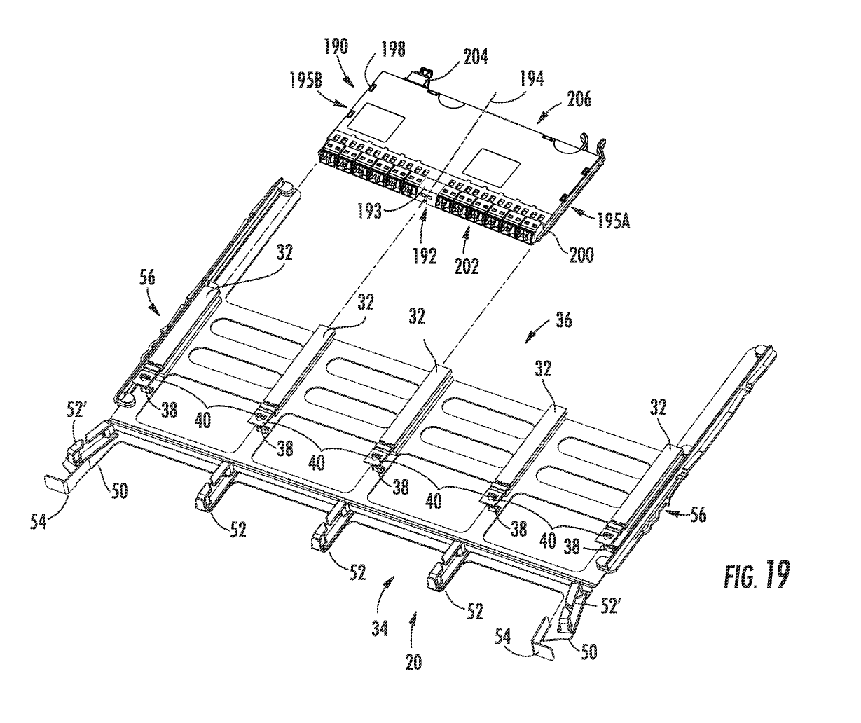

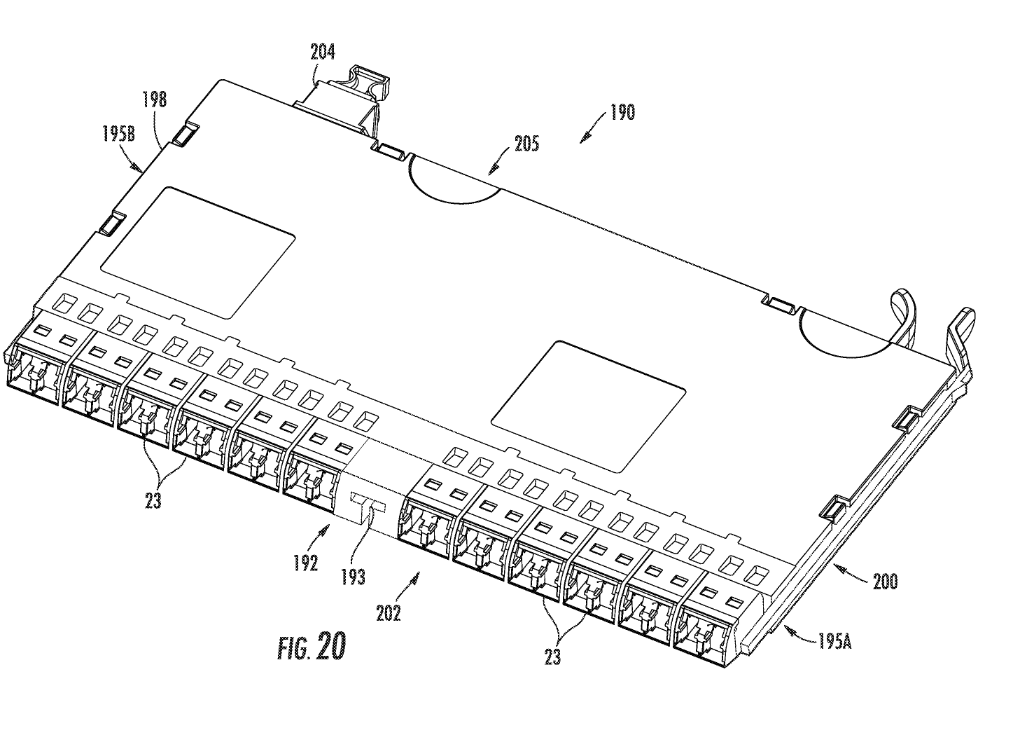

FIG. 19 illustrates another alternate fiber optic module 190 that may be provided in the fiber optic equipment trays 20 to support fiber optic connections and connection densities and bandwidths. FIG. 20 is a right front perspective view of the fiber optic module 190 of FIG. 19. In this embodiment, the fiber optic module 190 is designed to fit across two sets of module rail guides 32. A longitudinal receiver 192 is disposed through a center axis 194 and is configured to receive a module rail guide 32 in the fiber optic equipment tray 20 through an opening 193 in the receiver 192. Module rails 195A, 195B, similar to the module rails 28A, 28B of the fiber optic module 22 of FIGS. 1-13, are disposed on each side 198, 200 of the fiber optic module 190 that are configured to engage with tray channels 30 in the fiber optic equipment tray 20.

Up to twenty-four (24) fiber optic components 23 can be disposed in a front side 202 of the fiber optic module 190. In this embodiment, the fiber optic components 23 are comprised of up to twelve (12) duplex LC fiber optic adapters, which are connected to one twenty-four (24) fiber MPO fiber optic connector 204 disposed in a rear end 206 of the fiber optic module 190. Thus, with three (3) fiber optic equipment trays 20 disposed in the height of the chassis 12, a total of six (6) fiber optic modules 190 can be supported in a given 1-U space. Supporting up to twenty-four (24) fiber optic connections per fiber optic module 190 equates to the chassis 12 supporting up to one hundred forty-four (144) fiber optic connections, or seventy-two (72) duplex channels, in a 1-U space in the chassis 12 (i.e., twenty-four (24) fiber optic connections multiplied by six (6) fiber optic modules 190 in a 1-U space). Thus, the chassis 12 is capable of supporting up to one hundred forty-four (144) fiber optic connections in a 1-U space by twenty (24) simplex or twelve (12) duplex fiber optic adapters being disposed in the fiber optic modules 190. Supporting up to twenty-four (20) fiber optic connections per fiber optic module 190 equates to the chassis 12 supporting one hundred twenty (120) fiber optic connections, or sixty (60) duplex channels, in a 1-U space in the chassis 12 (i.e., twenty (20) fiber optic connections multiplied by six (6) fiber optic modules 190 in a 1-U space). Thus, the chassis 12 is also capable of supporting up to one hundred twenty (120) fiber optic connections in a 1-U space by twenty (20) simplex or ten (10) duplex fiber optic adapters being disposed in the fiber optic modules 190.

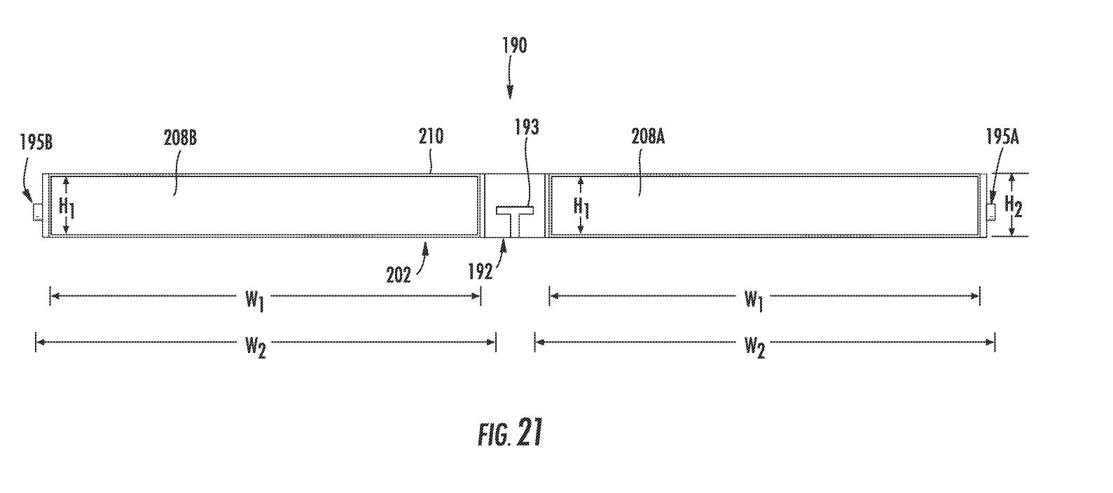

FIG. 21 illustrates a front view of the fiber optic module 190 of FIGS. 19-20 without loaded fiber optic components 23 in the front side 202 to further illustrate the form factor of the fiber optic module 190. Front openings 208A, 208B are disposed on each side of the receiver 192 and through the front side 202 of a main body 210 of the fiber optic module 190 to receive the fiber optic components 23. The widths W₁ and W₂ and the heights H₁ and H₂ are the same as in the fiber optic module 22 as illustrated in FIG. 13. Thus, in this embodiment, the width W₁ of front openings 208A, 208B is designed to be at least eighty-five percent (85%) of the width W₂ of the front side 202 of the main body 210 of the fiber optic module 190. The greater the percentage of the width W₁ to width W₂, the larger the area provided in the front openings 208A, 208B to receive fiber optic components 23 without increasing the width W₂.

The width W₁ of front openings 208A, 208B could each be designed to be greater than eighty-five percent (85%) of the width W₂ of the front side 202 of the main body 210 of the fiber optic module 190. For example, the width W₁ could be designed to be between ninety percent (90%) and ninety-nine percent (99%) of the width W₂. As an example, the width W₁ could be less than ninety (90) mm. As another example, the width W₁ could be less than eighty-five (85) mm or less than eighty (80) mm. For example, width W₁ may be eighty-three (83) mm and width W₂ may be eighty-five (85) mm, for a ratio of width W₁ to width W₂ of 97.6%. In this example, the front openings 208A, 208B may support twelve (12) fiber optic connections in the widths W₁ to support fiber optic connection density of at least one fiber optic connection per 7.0 mm of width W₁ of the front openings 208A, 208B. Further, each of the front openings 208A, 208B may support twelve (12) fiber optic connections in the widths W₁ to support a fiber optic connection density of at least one fiber optic connection per 6.9 mm of width W₁ of the front openings 208A, 208B.

Further as illustrated in FIG. 21, the height H₁ of front openings 208A, 208B could be designed to be at least ninety percent (90%) of the height H₂ of the front side 202 of the main body 210 of the fiber optic module 190. In this manner, the front openings 208A, 208B have sufficient height to receive the fiber optic components 23, while three (3) fiber optic modules 190 can be disposed in the height of a 1-RU space. As an example, the height H₁ could be twelve (12) mm or less or ten (10) mm or less. As an example, the height H₁ could be ten (10) mm and the height H₂ could be eleven (11) mm, for a ratio of height H₁ to height H₂ of 90.9%.

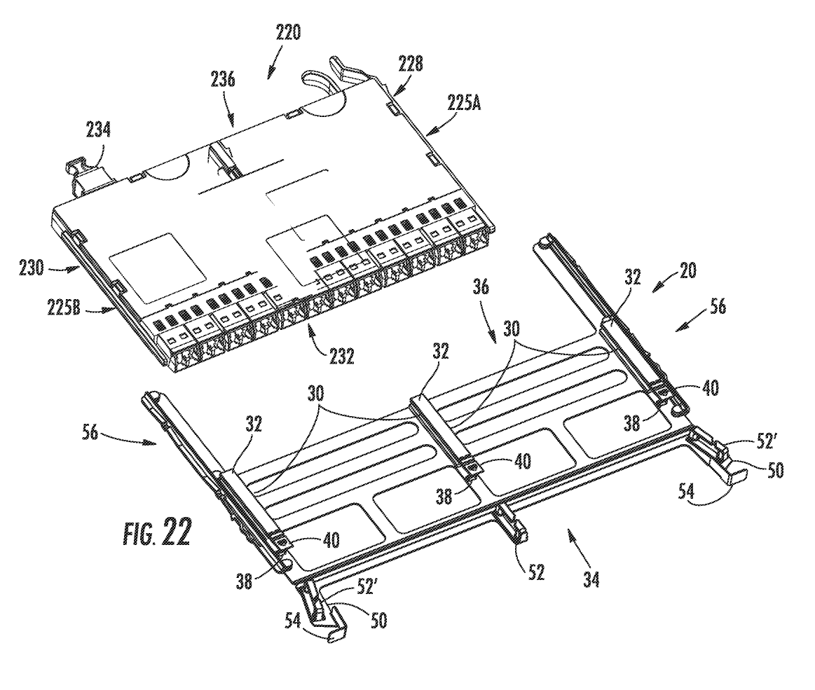

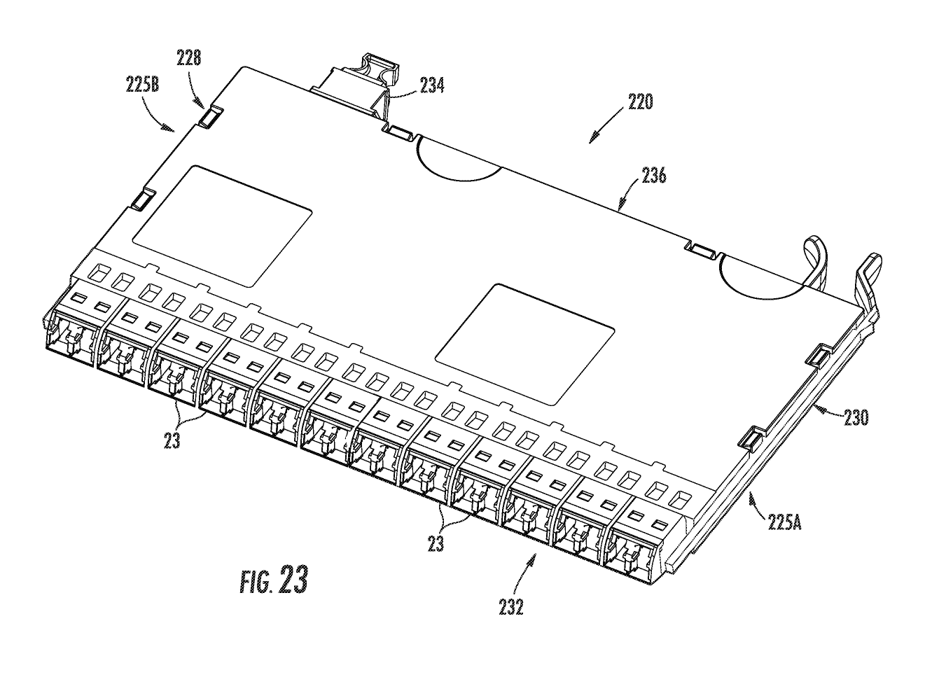

FIG. 22 illustrates another alternate fiber optic module 220 that may be provided in a fiber optic equipment tray 20′ to support a higher number of fiber optic connections and connection densities and bandwidths in a 1-U space. The fiber optic equipment tray 20′ in this embodiment is similar to the fiber optic equipment tray 20 previously discussed above; however, the fiber optic equipment tray 20′ only contains three (3) module rail guides 32 instead of five (5) module rail guides 32. Thus, the fiber optic equipment tray 20′ only supports two fiber optic modules 220 across a 1-RU width space. Thus, the fiber optic module 220 does not have to provide the channel 162 or receiver 192 of the fiber optic modules 160, 190, respectively, to be disposed within the fiber optic equipment tray 20′. FIG. 23 is a right front perspective view of the fiber optic module 220 of FIG. 22. The fiber optic module 220 is designed to fit across one set of module rail guides 32 in the fiber optic equipment tray 20′. Module rails 225A, 225B, similar to the module rails 28A, 28B of the fiber optic module 22 of FIGS. 1-13, are disposed on each side 228, 230 of the fiber optic module 220 that are configured to engage with tray channels 30 in the fiber optic equipment tray 20′, as illustrated in FIG. 22.

Up to twenty-four (24) fiber optic components 23 can be disposed in a front side 232 of the fiber optic module 220. In this embodiment, the fiber optic components 23 are comprised of up to twelve (12) duplex LC fiber optic adapters, which are connected to one twenty-four (24) fiber MPO fiber optic connector 234 disposed in a rear end 236 of the fiber optic module 220. Thus, with three (3) fiber optic equipment trays 20′ disposed in the height of the chassis 12, a total of six (6) fiber optic modules 220 can be supported in a given 1-U space. Supporting up to twenty-four (24) fiber optic connections per fiber optic module 220 equates to the chassis 12 supporting up to one hundred forty-four (144) fiber optic connections, or seventy-two (72) duplex channels, in a 1-U space in the chassis 12 (i.e., twenty-four (24) fiber optic connections multiplied by six (6) fiber optic modules 220 in a 1-U space). Thus, the chassis 12 is capable of supporting up to one hundred forty-four (144) fiber optic connections in a 1-RU space by twenty (24) simplex or twelve (12) duplex fiber optic adapters being disposed in the fiber optic modules 220. Supporting up to twenty (20) fiber optic connections per fiber optic module 220 equates to the chassis 12 supporting one hundred twenty (120) fiber optic connections, or sixty (60) duplex channels, in a 1-RU space in the chassis 12 (i.e., twenty (20) fiber optic connections multiplied by six (6) fiber optic modules 220 in a 1-U space). Thus, the chassis 12 is also capable of supporting up to one hundred twenty (120) fiber optic connections in a 1-U space by twenty (20) simplex or ten (10) duplex fiber optic adapters being disposed in the fiber optic modules 220.

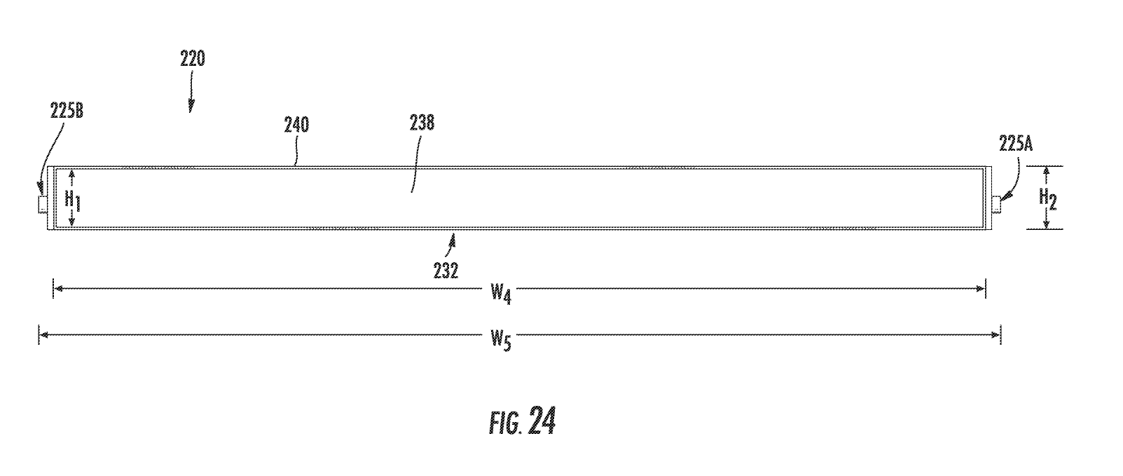

FIG. 24 illustrates a front view of the fiber optic module 220 of FIGS. 22-23 without loaded fiber optic components 23 in the front side 232 to further illustrate the form factor of the fiber optic module 220 in this embodiment. A front opening 238 is through the front side 232 of a main body 240 of the fiber optic module 220 to receive the fiber optic components 23. Width W₄ of the front opening 238 is twice the width W₁ of the front opening 98 in the fiber optic module 22 illustrated in FIG. 13. Width W₅ of the front side 232 is about one-hundred eighty-eight (188) millimeters, which is slightly greater than about twice the width W₃ of the fiber optic module 22 illustrated in FIG. 13. The heights H₁ and H₂ are the same as in the fiber optic module 22 illustrated in FIG. 13. Thus, in this embodiment, the width W₄ of the front opening 238 is designed to be at least eighty-five percent (85%) of the width W₅ of the front side 232 of the main body 240 of the fiber optic module 220. The greater the percentage of the width W₄ to the width W₅, the larger the area provided in the front opening 238 to receive fiber optic components 23 without increasing the width W_{4.}

Width W₄ of the front opening 238 could be designed to be greater than eighty-five percent (85%) of the width W₅ of the front side 232 of the main body 240 of the fiber optic module 220. For example, the width W₄ could be designed to be between ninety percent (90%) and ninety-nine percent (99%) of the width of W₅. As an example, the width W₄ could be less than one hundred eighty (180) mm. As another example, the width W₄ could be less than one hundred seventy (170) mm or less than one hundred sixty (160) mm. For example, width W₄ may be one hundred sixty-six (166) mm and width W₅ may be 171 mm, for a ratio of width W₄ to width W₅ of 166/171=97%. In this example, the front opening 238 may support twenty-four (24) fiber optic connections in the width W₄ to support a fiber optic connection density of at least one fiber optic connection per 7.0 mm of width W₄ of the front opening 238. Further, the front opening 238 may support twenty-four (24) fiber optic connections in the width W₄ to support a fiber optic connection density of at least one fiber optic connection per 6.9 mm of width W₄ of the front opening 238.

Further, as illustrated in FIG. 24, the height H₁ of the front opening 238 could be designed to be at least ninety percent (90%) of the height H₂ of the front side 232 of the main body 240 of the fiber optic module 220. In this manner, the front opening 238 has sufficient height to receive the fiber optic components 23, while three (3) fiber optic modules 220 can be disposed in the height of a 1-RU space. As an example, the height H₁ could be twelve (12) mm or less or ten (10) mm or less. As an example, the height H₁ could be ten (10) mm and height H₂ could be eleven (11) mm, for a ratio of height H₁ to height H₂ of 90.9%.

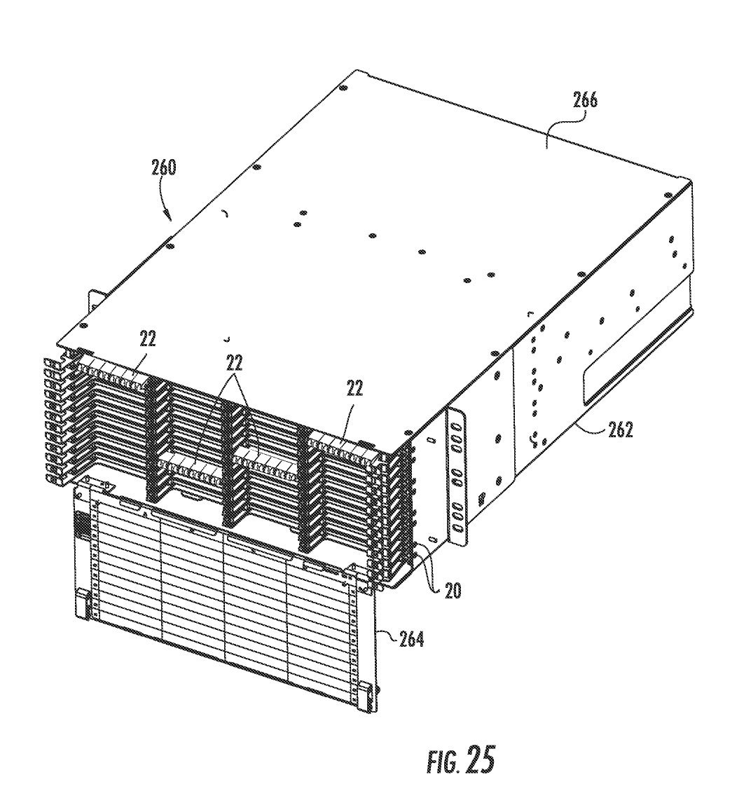

FIG. 25 illustrates another embodiment of fiber optic equipment 260 that can include fiber optic equipment trays previously described above and illustrated to support fiber optic modules. The fiber optic equipment 260 in this embodiment includes a 4-U sized chassis 262 configured to hold fiber optic equipment trays each supporting one or more fiber optic modules. The supported fiber optic equipment trays may be any of the fiber optic equipment trays 20, 20′ previously described above and thus will not be described again here. The supported fiber optic modules may be any of the fiber optic modules 22, 22′, 22″, 160, 190, 220 previously described above and thus will not be described again here. In this example, the chassis 262 is illustrated as supporting twelve (12) fiber optic equipment trays 20 each capable of supporting fiber optic modules 22.

The tray guides 58 previously described are used in the chassis 262 to support tray rails 56 of the fiber optic equipment trays 20 therein and to allow each fiber optic equipment tray 20 to be independently extended out from and retracted back into the chassis 262. A front door 264 is attached to the chassis 262 and is configured to close about the chassis 262 to secure the fiber optic equipment trays 20 contained in the chassis 262. A cover 266 is also attached to the chassis 262 to secure the fiber optic equipment trays 20. However, in the chassis 262, up to twelve (12) fiber optic equipment trays 20 can be provided. However, the fiber optic connection densities and connection bandwidths are still the same per 1-U space. The fiber optic connection densities and connection bandwidth capabilities have been previously described and equally applicable for the chassis 262 of FIG. 25, and thus will not be described again here.

Thus, in summary, the table below summarizes some of the fiber optic connection densities and bandwidths that are possible to be provided in a 1-U and 4-U space employing the various embodiments of fiber optic modules, fiber optic equipment trays, and chassis described above. For example, two (2) optical fibers duplexed for one (1) transmission/reception pair can allow for a data rate often (10) Gigabits per second in half-duplex mode or twenty (20) Gigabits per second in full-duplex mode. As another example, eight (8) optical fibers in a twelve (12) fiber MPO fiber optic connector duplexed for four (4) transmission/reception pairs can allow for a data rate of forty (40) Gigabits per second in half-duplex mode or eighty (80) Gigabits per second in full-duplex mode. As another example, twenty optical fibers in a twenty-four (24) fiber MPO fiber optic connector duplexed for ten (10) transmission/reception pairs can allow for a data rate of one hundred (100) Gigabits per second in half-duplex mode or two hundred (200) Gigabits per second in full-duplex mode. Note that this table is exemplary and the embodiments disclosed herein are not limited to the fiber optic connection densities and bandwidths provided below.

| | Max | Max | Number of | Number of | Bandwidth per 1U | Bandwidth per 1U | Bandwidth per 1U |
|---|---|---|---|---|---|---|---|
| | Fibers | Fibers | Connectors | Connectors | using 10 Gigabit | using 40 Gigabit | using 100 Gigabit |
| Connector | per | per | per 1 RU | per 4 RU | Transceivers | Transceivers | Transceivers |
| Type | 1RU | 4RU | Space | Space | (duplex) | (duplex) | (duplex) |
| Duplexed | 144 | 576 | 72 | 288 | 1,440 Gigabits/s. | 960 Gigabits/s. | 1,200 Gigabits/s. |
| LC | | | | | | | |
| 12-F MPO | 576 | 2,304 | 48 | 192 | 5,760 Gigabits/s. | 3,840 Gigabits/s. | 4,800 Gigabits/s. |
| 24-F MPO | 1,152 | 4,608 | 48 | 192 | 11,520 Gigabits/s. | 7,680 Gigabits/s. | 9,600 Gigabits/s. |

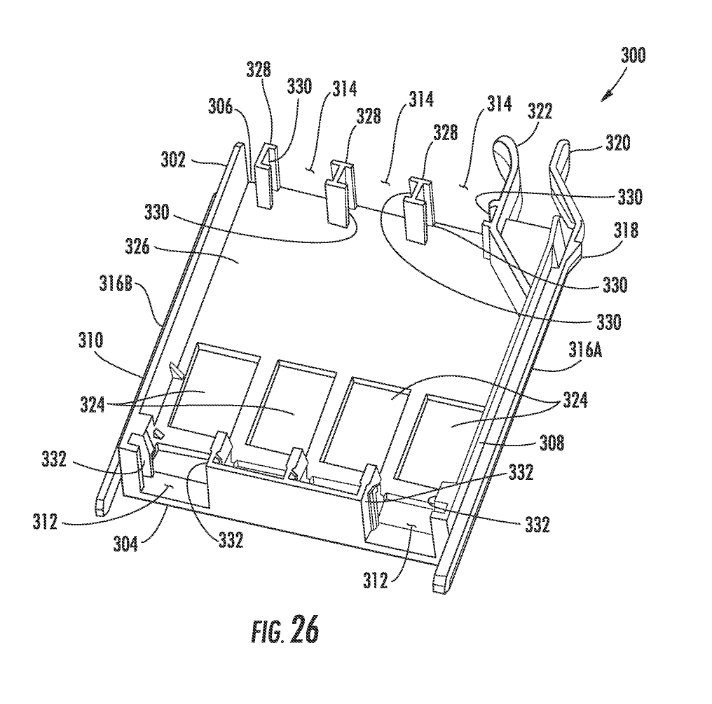

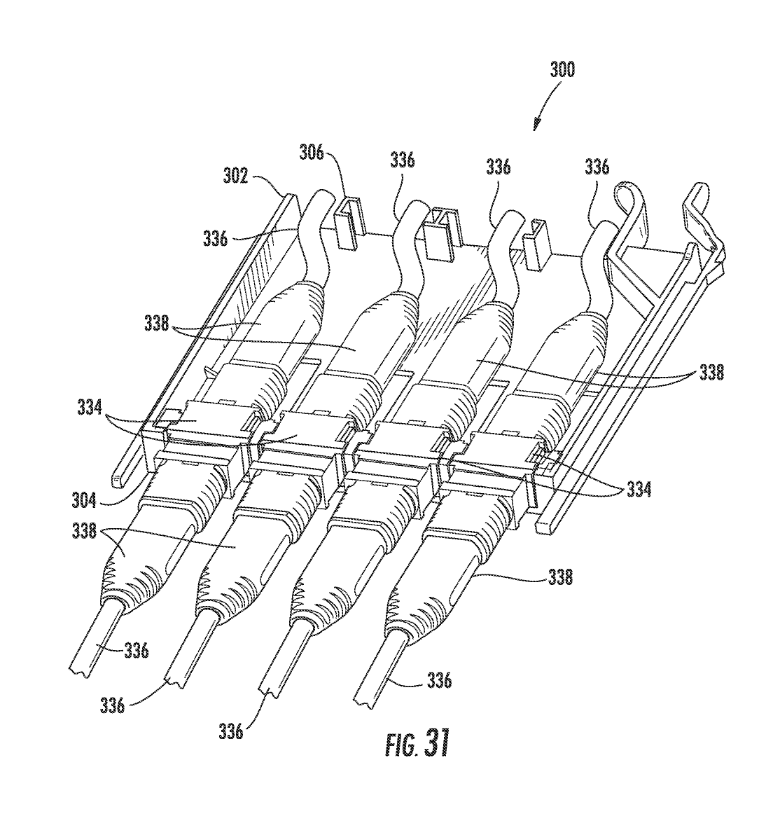

FIGS. 26-32 illustrate embodiments of a transition panel for use with one or more multi-fiber adapters, for example, a MPO adapter. An MPO adapter shall be understood to refer to any type of multi-fiber adapter including “MTP” adapters, which term may also be used in this description. For purposes of discussing these embodiments, the term “transition panel” will be used, but it should be understood that that term also includes a module, or any type of mechanism for the transitioning of fiber optic cable from a parked position to another location. The transition panel may be installed in a structure located in the fiber optic equipment rack. Such structure shall be understood to include any type of housing, enclosure or chassis, such terms being understood to be interchangeable. The chassis may include a tray, drawer or shelf on which the transition panel is disposed. In these embodiments, the transition panel is movably mounted in the chassis such that the transition panel may be slid forward and rearward to provide access to the front and/or rear of the transition panel.

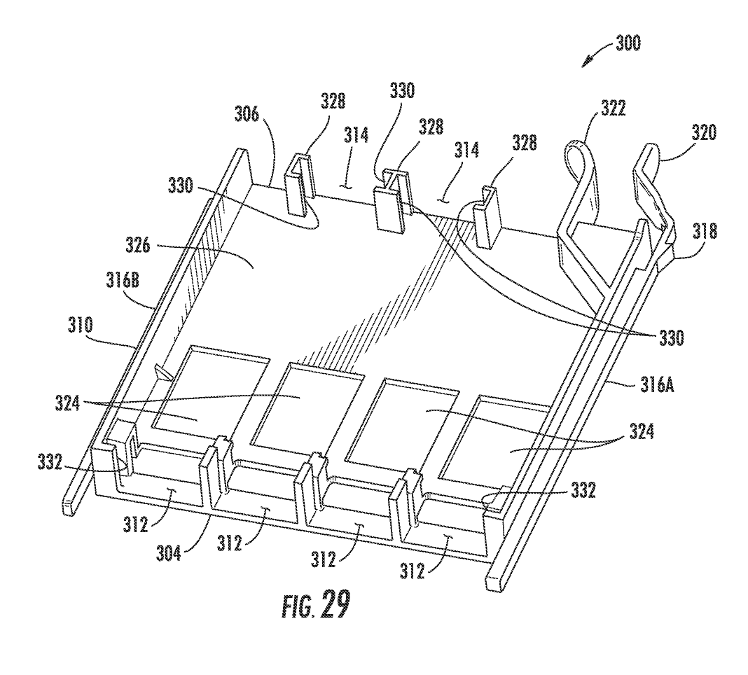

The transition panel may be configured to accept any number of MPO adapters. As such, the transition panel may have one or more parking ports on the back side of the transition panel, and one or more connection ports on the front side of the transition panel. Each parking port and connection port is configured to accept a MPO adapter. FIGS. 26-28 illustrate embodiments of a two-port transition panel and FIGS. 29-31 illustrate embodiments of a four-port transition panel. The terms “two-port” and “four-port” refer to the number of connection ports on the front side. There may be a different number of connection ports than parking ports on a transition panel.

Referring now to FIGS. 26 and 29, a two-port transition panel and a four-port transition, respectively, are illustrated. The following description applies to the both the two-port and the four-port transition panel and, therefore, the term transition panel 300 shall be used and understood to apply to either. The transition panel 300 has a housing 302 with a front 304, a back 306, a first side 308 and a second side 310. In the embodiment illustrated in FIG. 26, two connection ports 312 are located at the front 304 and three parking ports 314 are located at the back 306. In the embodiment illustrated in FIG. 29, four connection ports 312 are located at the front 304 and two parking ports 314 are located at the back 306. It should be understood that the transition panel 300 may include any number of connection ports 312 or parking ports 314. Panel rails 316A and 316B are disposed on the first side 308 and the second side 310, respectively. The panel rails 316A and 316B are configured to be inserted within tray channels 30 of module rail guides 32 disposed in the fiber optic equipment tray 20 in a similar fashion to the module rail guides (see FIGS. 3-5). The panel rails 316A and 316B allow the transition panel to be movably attached to the fiber optic tray 20 including to allow the transition panel 300 to be installed in and removed from the fiber optic tray 20. To remove the transition panel from the rear end 36 of the fiber optic tray 20, a latch 318 is disengaged by pushing a lever 320 inward towards the transition panel 300 to release the latch 318 from the module rail guide 32. (see FIGS. 2 and 3; see also, FIGS. 10A and 10B) To facilitate pushing the lever 320 inward towards the transition panel 300, a finger hook 322 is provided adjacent to the lever 320 so the lever 320 can easily be squeezed toward the finger hook 322 by a thumb and index finger. Access holes 324 extend through bottom 326 to allow for finger access to adapters and connectors in the transition panel 300.

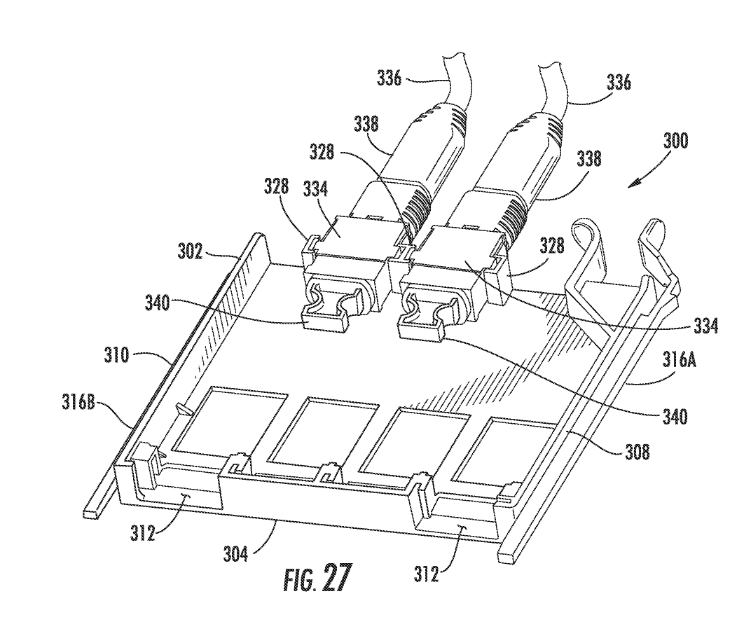

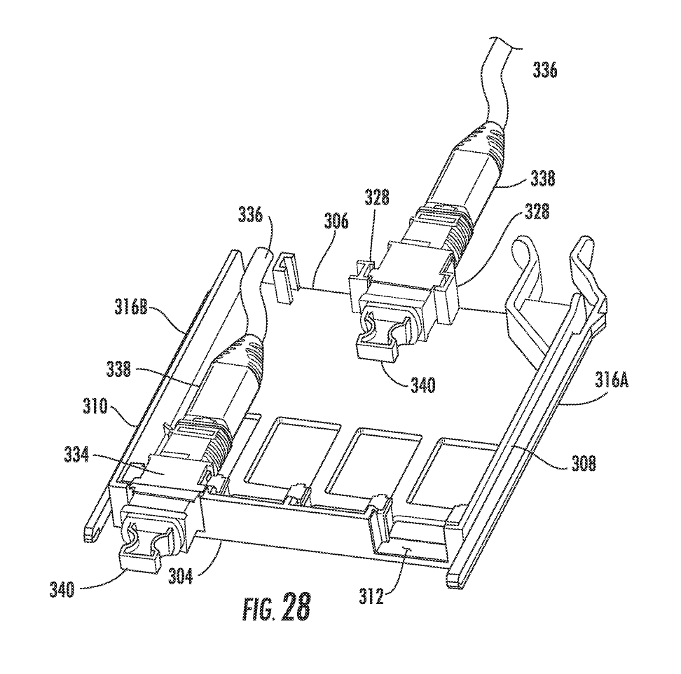

The parking ports 314 are defined by channels 328 having guide slots 330. In this manner, opposing guide slots locate on either side of the parking port 314. In a similar fashion, the connection ports 312 have opposing guide slots 332. The guide slots 330 and 332 are configured to accept an MPO adapter 334 such that the MPO adapter 334 may be releasably locked in the guide slot 330, 332, which is illustrated in FIGS. 27 and 28. The MPO adapter 334 may receive a connector 338 that is configured to connect 12 fibers, 24 fibers or any number of optical fibers so as to mate the connector with the MPO adapter 334. In this regard, a fiber optic cable 336 with multiple optical fibers may be terminated/connectorized with a multiple fiber connector 338 and the multiple fiber connector 338 may then be received by the MPO adapter 334. Additionally, the MPO adapter 334 may be installed on the back 306 of the transition panel 300, on the front 304 of the transition panel 300, or on both the front 304 and the back 306 of the transition panel 300.

In the embodiment shown in FIG. 27 two MPO adapters 334 are shown inserted and releasably locked in respective parking ports 314. A fiber optic cable 336 terminated with a multiple fiber connector 338 extends to the transition panel 300. The MPO adapter 334 receives in one end the fiber optic connector 338 and has in the other end a dust cap 340. The fiber optic cable 336 may be a trunk cable routed to the chassis for connection to another fiber optic cable or component at a later time. In such a case, the fiber optic cables 336 may be “parked” by connecting the fiber optic connector 338 to the MPO adapter 334 until one or both of the fiber optic cables 336 are intended to be further connected. The MPO adapter 334 mounted in the back 306 of the transition panel 300 allows incremental trunk connections to be made into the back 306 of the transition panel 300 from the rear of the fiber optic equipment rack without disrupting service to the fiber optic equipment rack. Once the trunk connection has been made to the MPO adapter 334, the chassis in which the transition panel 300 is located may be accessed from the front of the fiber optic equipment rack. The transition panel 300 may be slid forward to provide access from the front of the fiber optic equipment rack to the trunk cable 336 connected to the MPO adapter 334 on the back 306 of the transition panel 306. The mated connection of the trunk cable 336 to the MPO adapter may be removed from the back 306 of the transition panel 300 and moved to the front 304 of the transition panel 300 inserted and releasably locked in one of the connection ports 312 without un-mating the connection. Such a situation is shown in FIG. 28. The transition panel 300 may then be slid rearwardly back into the chassis.

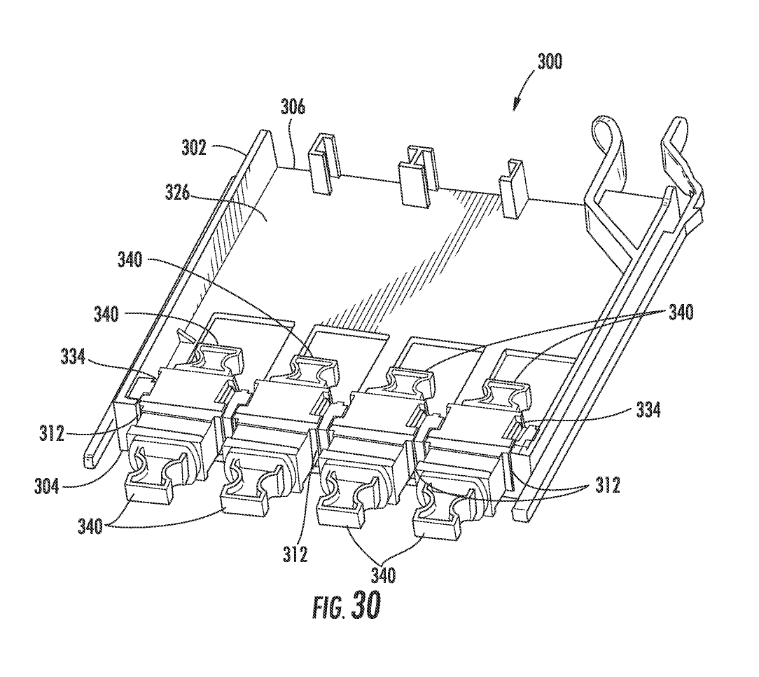

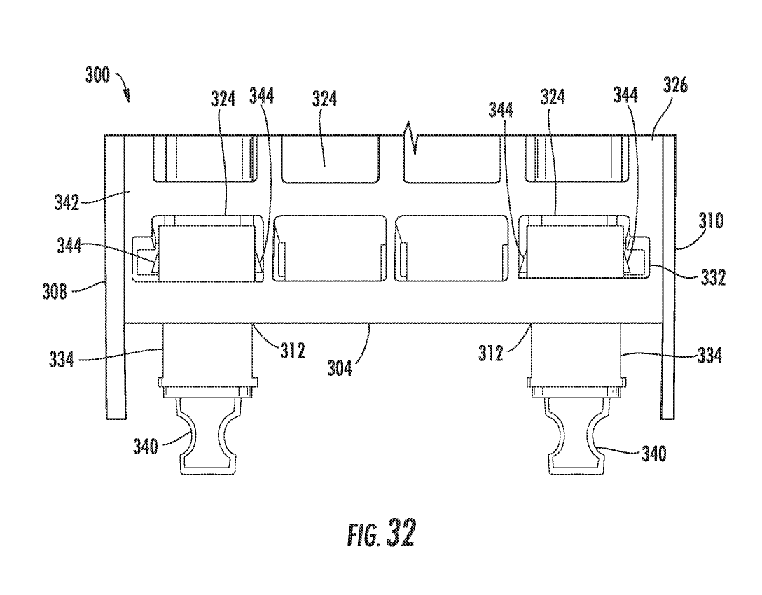

On the front 304 of the transition panel 300, the MPO adapters 334 can be installed with or without a trunk cable being connected, as shown in FIGS. 30 and 32. In FIG. 30, a four-port transition panel is illustrated with an MPO adapter 334 installed in each of the four connection ports 312 with dust caps 340 inserted in each end of the MPO adapter 334. In FIG. 32, the four-port transitional panel 300 is shown with an MPO adapter 334 installed in each of the four connection ports 312 and with a fiber optic cables 336 connected to both sides of the MPO adapter 334 through connectors 338.

Referring now to FIG. 32, there is illustrated a view of the underside 342 of the transition panel 300 at the front 304. The transition panel 300 has two MPO adapters 334, each inserted in one of the connection ports 312. To insert the MPO adapter 334 in the connection port 312, the MPO adapter 334 may be positioned in a normal orientation and pushed toward the back 306 of the transition panel 300 until a retaining clip 344 slides past the channel 332 walls. The MPO adapter 334 may be prevented from dislodging by the channel 332 walls once the retaining clip has “sprung” out to a size greater than the opening dimension. Also, the MPO adapter 334 may be removed from the front end installed position by conventional means with a tool designed to depress the retainer clip from the underside an access opening 324 in the transition panel 300. The MPO adapter 334 may be removed once the transition panel 300 has been removed from the chassis by flexing the transition panel 300 in a direction to increase the opening at the top to allow opening of an overhang feature 346 to be larger than the retainer clip 344 width, therefore allowing the MPO adapter 334 to tilt enough to slide upwards past the overhang 346.

Other types of adapters may be used including, without limitation, SC, LC simplex, duplex, ganged, etc. Additionally, in another embodiment, the parking port314 may consist of guide slots 330 with a looser fit and the back wall of the guide slots 330 having a protrusion to detent or catch the retaining clip 344 preventing the MPO adapter 334 from disengaging while installing the trunk connector 338 yet allowing the MPO adapter 334 to be removed by sliding in a rearward direction while pulling upwards. Another embodiment may include the connection port 312having a lead-in ramp to allow the MPO adapter 334 to install from the top side by allowing the retainer clips 344 to gradually depress as they slide past the overhang detent. Another embodiment includes a tool that is threaded through the shelf space allowing the trunk connector to be attached to the tool. The tool may be pulled forward to access the connector 338 and install it to the front 304 of the transition panel 300. In another embodiment, the trunk connector 338 received by the MPO adapter 334 on the back 306 of the transition panel 300 may be removed from the MPO adapter 334 and connected to an adapter on another panel that is configured to be accessed for providing service. In another embodiment, an extendable and retractable cord may be employed to take up or release an appropriate amount of length of the trunk cable 336 as the transition panel 300 is slid forward and rearward, eliminating the need for an additional connection.

As used herein, the terms “fiber optic cables” and/or “optical fibers” include all types of single mode and multi-mode light waveguides, including one or more optical fibers that may be upcoated, colored, buffered, ribbonized and/or have other organizing or protective structure in a cable such as one or more tubes, strength members, jackets or the like. Likewise, other types of suitable optical fibers include bend-insensitive optical fibers, or any other expedient of a medium for transmitting light signals. An example of a bend-insensitive optical fiber is ClearCurve® Multimode fiber commercially available from Corning Incorporated.

It is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A fiber optic apparatus, comprising:
a panel, having a front and a back, wherein the panel is mountable in a chassis;
a parking port in the back, wherein the parking port is adapted to removably receive an adapter; and
a connection port in the front, wherein the connection port is adapted to removably receive the adapter, wherein one end of the adapter opens toward the front and another end of the adapter opens toward the back, and wherein the adapter is selectively movable between the parking port and the connection port.

2. The fiber optic apparatus of claim 1, wherein the adapter is a multiple fiber adapter.

3. The fiber optic apparatus of claim 1, wherein the adapter is removably received in the parking port, and wherein a connector attached to a fiber optic cable inserts in the end opening toward the back.

4. The fiber optic apparatus of claim 3, wherein the fiber optic cable is a trunk cable.

5. The fiber optic apparatus of claim 4, wherein the adapter is moved from the parking port to the connection port and is removably received in the connection port.

6. The fiber optic apparatus of claim 1, wherein the adapter is removably received in the connection port, and wherein a connector attached to a fiber optic cable is inserted in the end of the adapter opening toward the back, and wherein another connector attached to another fiber optic cable is inserted in the other end of the adapter opening toward the front.

7. The fiber optic apparatus of claim 1, wherein the parking port comprises a plurality of parking ports.

8. The fiber optic apparatus of claim 1, wherein the connection port comprises a plurality of connection ports.

9. The fiber optic apparatus of claim 1, wherein the adapter is configured to releasably lock in the parking port.

10. The fiber optic apparatus of claim 1, wherein the adapter is configured to releasably lock in the connection port.

11. The fiber optic apparatus of claim 1, further comprising,
a first side and a second side, and
a panel rail attached to one or both of the first side and the second side, wherein the panel rails is adapted to movably mount the panel in a tray mounted in the chassis.

12. The fiber optic apparatus of claim 1, wherein the chassis is mounted in a fiber optic equipment rack.

13. A fiber optic apparatus, comprising:
a panel, having a front and a back, wherein the panel is mountable in a chassis;
a parking port disposed in the back; and
a connection port disposed in the front, wherein a multiple fiber adapter is removably received in the parking port, and wherein a connector attached to a fiber optic cable is inserted in an end of the fiber optic adapter opening toward the back, wherein the multiple fiber adapter is movable from the parking port to the connection port.

14. The fiber optic apparatus of claim 13, wherein the multiple fiber adapter is removably received in the connection port.

15. The fiber optic apparatus of claim 14, wherein another connector attached to another fiber optic cable is inserted in another end of the multiple fiber adapter opening toward the front.

16. A method for connecting fiber optic cables, comprising:
providing a transition panel, wherein the transition panel has a parking port and a connection port;
inserting an adapter in the parking port;
extending to the transition panel a first fiber optic cable with a first connector attached to an end;
inserting the first connector in an end of the adapter;
moving the adapter from the parking port to the connection port;
extending to the transition panel a second fiber optic cable with a second connector attached to an end; and
inserting the second connector in another end of the adapter.

17. The method of claim 16, wherein the adapter is a multiple fiber adapter.

18. The method of claim 16, wherein the first fiber optic cable is a trunk cable.

19. The method of claim 16, wherein the transition panel movably mounted in a tray, wherein the tray is mounted in a chassis.

20. The method of claim 19, wherein the chassis is mounted in a fiber optic equipment rack.
